(19) United States
(12) Patent Application Publication
(10) Pub. No.: US 2008/0167413 A1
(43) Pub. Date: Jul. 10, 2008

(54) Organic-inorganic composite composition, plastic substrate, gas barrier laminate film, and image display device

(76) Inventors: Taisei Nishimi, Minami-ashigara-shi (JP); Hiroshi Iwanaga, Minami-ashigara-shi (JP); Hiroshi Arakatsu, Minami-ashigara-shi (JP); Seiya Sakurai, Minami-ashigara-shi (JP)

Correspondence Address: BUCHANAN, INGERSOLL & ROONEY PC, POST OFFICE BOX 1404, ALEXANDRIA, VA, 22313-1404, US

(21) Appl. No.: 12/004,036

(22) Filed: Dec. 20, 2007

Related U.S. Application Data
(62) Division of application No. 11/061,478, filed on Feb. 22, 2005, now abandoned.

(30) Foreign Application Priority Data
Feb. 20, 2004 (JP) 2004-043970

(51) Int. Cl. C08K 3/22

(52) U.S. Cl. 524/430

(57) ABSTRACT

In a gas barrier laminate film comprising a base material film containing an inorganic compound and at least one set of inorganic layer and organic layer formed on the base material film, the base material film is formed with a resin having a glass transition temperature of 25° C. or higher. A gas barrier laminate film that has superior durability, heat resistance and gas barrier performance, shows a small difference in coefficient of linear expansion relative to a contiguous layer and can maintain superior gas barrier property even if it is bent is provided.

### CROSS REFERENCE TO RELATED APPLICATION

This application is a divisional of application Ser. No. 11/061,478, filed Feb. 22, 2005, which claims priority to Japanese Application No. 2004-043970, filed Feb. 20, 2004, the disclosures of all of which are incorporated herein by reference in their entirety.

### BACKGROUND OF THE INVENTION

1. Field of the Invention

The present invention relates to a gas barrier laminate film having superior gas barrier property and an image display device utilizing the film. In particular, the present invention relates to a gas barrier laminate film that is to be used as a substrate of flexible organic electroluminescence device (henceforth referred to as “organic EL device”) and an organic EL device utilizing the gas barrier laminate film. The present invention also relates to a novel organic-inorganic composite composition, and further relates to a plastic substrate useful for image display devices.

2. Description of the Related Art

Conventionally, gas barrier films prepared by forming a thin film of metal oxide such as aluminum oxide, magnesium oxide or silicon oxide on a surface of a plastic substrate or film have been widely used in packaging of articles which require shielding of various gases such as water vapor and oxygen, and packaging use for preventing deterioration of food, industrial materials, medical supplies and so forth. In addition to the packaging use, gas barrier films are also used in liquid crystal display devices, solar cells, substrates for electroluminescence (EL) devices and so forth. Transparent base materials, of which applications especially for liquid crystal display devices, EL devices and so forth are spreading, are needed in recent years to satisfy highly sophisticated requirements in addition to the needs of lighter weight and larger sizes. For example, they must have long-term reliability and higher degree of freedom of the shape, they must enable display on a curved surface, and so forth. Thus, as transparent base materials that satisfy such sophisticated requirements, plastic base materials come to be adopted as an alternative to conventional glass substrates, which are heavy, readily broken and difficult to be formed in a larger size.

Plastic films not only satisfy the aforementioned requirements, but also show more favorable productivity compared with glass substrates because a roll-to-roll system can be used for them, and therefore they are more advantageous also in view of cost reduction. However, film base materials of transparent plastics etc. have a drawback that their gas barrier property is inferior to that of glass base materials. If a base material having poor gas barrier property is used, water vapor and air permeate the material to, for example, degrade liquid crystals in a liquid crystal cell, form display defects and thereby degrade display quality. In order to solve this problem, gas barrier film base materials in which a metal oxide thin film is formed on a film substrate have been developed.

As gas barrier films used for packaging materials or liquid crystal display devices, those comprising a plastic film on which silicon oxide is vapor-deposited (see Japanese Patent Publication (Kokoku) No. 53-12953 (pages 1 to 3)) and those comprising a plastic film on which aluminum oxide is vapor-deposited (see Japanese Patent Laid-open Publication (Kokai) No. 58-217344 (pages 1 to 4)) are known. These films have a water vapor permeability of about 1 g/m²/day. However, due to production of liquid crystal displays of larger size and development of high precision displays in recent years, gas barrier performance of film substrates is even required to satisfy gas barrier performance of about 0.1 g/m²/day in terms of water vapor permeability property.

Furthermore, development of organic EL displays, high precision color liquid crystal displays and so forth has progressed in recent days, which require further higher gas barrier property, and therefore base materials satisfying performances of maintaining transparency usable for these and having higher barrier performance, in particular, barrier performance of less than 0.1 g/m₂/day in terms of water vapor permeability, have come to be required. In order to meet such demands, studied is film formation by the sputtering method or CVD method, in which a thin film is formed by using plasma generated by glow discharge under a low pressure condition, as a means that can be expected to provide higher barrier performance. Moreover, techniques of preparing a barrier film having an alternate laminate structure of organic layers and inorganic layers by the vacuum deposition method are proposed (see U.S. Pat. No. 6,268,695 (page 4, [2-5] to page 5, [4-49]) and Japanese Patent Laid-open Publication No. 2003-53881 (page 3, [0006] to page 4, [0008])).

However, for use as a flexible organic EL display substrate, gas barrier property and flex resistance of the gas barrier films described in these documents just mentioned are insufficient, and therefore further improvement has been desired. Moreover, since heat resistance of polymer layers formed by the methods of these documents is also insufficient in view of difference in coefficient of linear expansion relative to the adjacent layer or the like. Such heat resistance is required at the time of disposing TFT in active matrix type image devices, and therefore further improvement has been required. Moreover, since adhesion between the aforementioned polymer layers and an inorganic layer is also insufficient, improvement has been desired also in this point.

Further, in recent years, organic-inorganic composite compositions in which a resin as an organic polymer substance and a metal oxide as an inorganic material are compatibly solubilized have come to attract attentions as materials that compensate characteristics of organic material and inorganic material and make the most of them, and researches and developments of organic-inorganic composite compositions are actively conducted. For example, application of an organic-inorganic composite composition based on a hydrolytic condensate of an epoxy resin and an alkoxysilane having glycidyl group to a substrate for image display devices has been attempted (see, for example, Japanese Patent Laid-open Publication No. 10-54979 (all pages)). However, organic-inorganic composite compositions have drawbacks that they lack flexibility and thus they are brittle. Further, organic-inorganic composite compositions using polycarbonate as a more flexible thermoplastic resin and an inorganic material is also known (see, for example, International Patent Publication WO99/14274 (all pages)). However, heat resistance of the polycarbonate used in such compositions is insufficient.

### SUMMARY OF THE INVENTION

The present invention was accomplished in view of the aforementioned problems, and the first object of the present invention is to provide a composition and plastic substrate that can realize a substrate for image display devices showing superior optical characteristics and superior display quality, and further provide an image display device utilizing them, in particular, a plastic substrate that does not cause, after film formation of transparent conductive film, reduction of conductivity of the conductive film even after heat treatment or disposition of an oriented film, barrier film or the like and that has superior mechanical characteristics, and an image display device utilizing such a plastic substrate.

The second object of the present invention is to provide a gas barrier laminate film that has superior durability, heat resistance and gas barrier performance, shows a small difference in coefficient of linear expansion relative to an contiguous layer and can maintain superior gas barrier property even if it is bent, and an image display device of superior durability utilizing such a gas barrier laminate film.

The inventors of the present invention conducted various researches in order to develop a gas barrier laminate film that has both of favorable gas barrier property and heat resistance, shows favorable precision and durability when used as a liquid crystal display substrate or an organic EL substrate and shows a small difference in coefficient of linear expansion relative to an contiguous layer. As a result, they found that the aforementioned objects could be achieved by using a base material film comprising a particular resin and inorganic compound, and thus accomplished the present invention.

That is, the objects of the present invention can be achieved by the gas barrier laminate film, image display device, organic-inorganic composite compositions and plastic substrate described below.

(1) An organic-inorganic composite composition comprising an inorganic compound and a resin having a glass transition temperature of 250° C. or higher.
(2) The organic-inorganic composite composition according to (1), wherein the resin is a polymer having a spiro structure represented by the following formula (I) or a polymer having a cardo structure represented by the following formula (II):

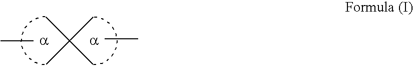

wherein, in the formula (I), the rings a represent a monocyclic or polycyclic ring, and two of the rings are bound via a spiro bond,

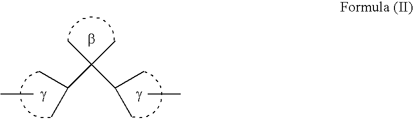

wherein, in the formula (II), the ring β and the rings γ independently represent a monocyclic or polycyclic ring, and two of the rings y may be identical or different and bond to one quaternary carbon atom in the ring β.
(3) The organic-inorganic composite composition according to (1) or (2), wherein the inorganic compound is a metal oxide obtained by hydrolysis and polycondensation reactions based on a sol-gel method.
(4) The organic-inorganic composite composition according to any one of (1) to (3), wherein the inorganic compound has a negative coefficient of linear expansion.
(5) The organic-inorganic composite composition according to any one of (1) to (4), wherein the metal atom constituting the metal oxide is a metal atom selected from the group consisting of silicon, zirconium, aluminum, titanium and germanium.
(6) A plastic substrate comprising the organic-inorganic composite composition according to any one of (1) to (5).
(7) The plastic substrate according to (6), which has a content of the metal oxide of 5 to 70 weight % and a thickness of 40 to 200 μm.
(8) The plastic substrate according to (6) or (7), wherein thermal deformation temperature of the substrate is increased by 2° C. or more by inclusion of the metal oxide.
(9) The plastic substrate according to any one of (6) to (8), wherein thermal expansion coefficient of the substrate is decreased by 20 ppm/° C. or more by inclusion of the metal oxide.
(10) Aplastic substrate having a transparent conductive layer, which comprises the plastic substrate according to any one of (6) to (9) and a transparent conductive layer formed on the plastic substrate.
(11) A gas barrier laminate film comprising a base material film containing an inorganic compound and at least one set of inorganic layer and organic layer formed on the base material film, wherein the base material film is a film comprising a resin having a glass transition temperature of 250° C. or higher.
(12) The gas barrier laminate film according to (11), wherein the inorganic compound is a metal oxide obtained by hydrolysis and polycondensation reactions based on a sol-gel method.
(13) The gas barrier laminate film according to (11) or (12), wherein the inorganic compound has a negative coefficient of linear expansion.
(14) The gas barrier laminate film according to any one of (11) to (13), wherein the base material film is a film comprising a polymer having a spiro structure represented by the formula (I) or a polymer having a cardo structure represented by the formula (II).
(15) The gas barrier laminate film according to any one of (11) to (14), wherein the base material films is the plastic substrate according to any one of (6) to (10).
(16) An image display device utilizing the plastic substrate according to any one of (6) to (10) or the gas barrier laminate film according to any one of (11) to (15) as a substrate.

By using the novel organic-inorganic composite composition of the present invention, a plastic substrate and gas barrier laminate film showing superior mechanical characteristics and optical characteristics can be provided.

The gas barrier laminate film of the present invention comprises a base material film comprising a resin having a glass transition temperature of 250° C. or higher and at least one set of inorganic layer and organic layer formed on the base material film. With this configuration, a gas barrier laminate film showing both of superior durability and superior heat resistance as well as high gas barrier performance and high flexibility can be obtained according to the present invention.

Further, the image display device of the present invention utilizes the plastic substrate or gas barrier laminate film of the present invention as a substrate. Thanks to this characteristic, an image display device having a flexible substrate and showing high precision and superior durability, especially such an organic EL device, can be provided by the present invention.

### BEST MODE FOR CARRYING OUT THE INVENTION

Hereafter, the organic-inorganic composite composition, plastic substrate, gas barrier laminate film and image display device of the present invention will be explained in detail. For convenience of the explanation, the present invention will be explained in the order of the gas barrier laminate film of the present invention (henceforth referred to as the “film of the present invention”), organic-inorganic composite composition, plastic substrate and image display device of the present invention. Although the characteristics of the present invention may be explained hereafter by referring to representative embodiments of the present invention, the present invention is not limited to such embodiments. The ranges expressed with “to” in the present specification mean ranges including the numerical values indicated before and after “to” as a lower limit value and upper limit value.

### [Gas Barrier Laminate Film]

The film of the present invention is a gas barrier laminate film comprising a base material film containing an inorganic compound and at least one set of inorganic layer and organic layer formed on the base material film. Hereafter, the members constituting the gas barrier laminate film of the present invention will be explained one by one.

### <Base Material Film>

### (Inorganic Compound)

The base material film used in the film of the present invention contains an inorganic compound. As the inorganic compound contained in the base material film, those generally used as a filling material (filler) for resins can be used without particular limitation.

Examples of the inorganic compound include, for example, metal oxides such as alumina, zinc oxide, titanium oxide, cerium oxide, calcium oxide, magnesium oxide and niobium oxide; metal hydroxides such as calcium hydroxide, magnesium hydroxide, and aluminum hydroxide; carbonates such as basic magnesium carbonate, calcium carbonate, magnesium carbonate, zinc carbonate, barium carbonate, dawsonite and hydrotalcite; sulfates such as calcium sulfate, barium sulfate, magnesium sulfate and gypsum fibers; silicate compounds such as calcium silicates (wollastonite, xonotlite etc.), talc, clay, mica, montmorillonite, bentonite, activated clay, sepiolite, imogolite, palygorskite (attapulgite), sericite, kaolin, vermiculite and smectite; glass fillers such as glass fibers, milled glass fibers, glass beads, glass flakes and glass balloons; silicic acid compounds such as silica and silica sand and ferrites. Further examples of inorganic fillers include red phosphorus, carbon black (acetylene black, oil furnace black, lamp black etc.), graphite, graphite whiskers, carbon nanotubes, fullerenes, carbon fibers, metal fibers, various metal-coated fibers, potassium titanate whiskers, aluminum borate whiskers and so forth.

The aforementioned filling agents (fillers) for resins can be classified into spherical (granular), needlelike (fibrous) and tabular fillers depending on the shapes thereof as described in, for example, Polymer ABC Handbook (Edited by Research Group on Alloy, Blend, Composites of The Society of Polymer Science, Japan, pp. 480-490, (2001), published by NTN Co., Ltd.

When the inorganic compound has a spherical (granular) shape, it preferably has an average particle size of 5 nm to 1 μm, more preferably 5 to 100 nm, still more preferably 5 to 50 nm.

As these particles of the inorganic compound, commercial products may be used, or those synthesized according to the description of Chemistry of Materials, vol. 5, p. 412, 1993 or the like may be used. As the commercial products of inorganic compound particles, for example, Snowtex and alumina sol sold by Nissan Chemical Industries, Ltd. and fullerenes (C₆₀, C₇₀) sold by Tokyo Kasei Kogyo Co., Ltd. can be preferably used.

When the inorganic compound has a needlelike (fibrous) shape, it preferably has an average aspect ratio of 5 to 10,000. With such an aspect ratio, the inorganic compound preferably has a diameter of 0.5 to 100 nm, more preferably 0.5 to 20 nm, still more preferably 0.5 to 5 nm. Average length (average length in the longitudinal direction) of the inorganic compound is preferably 5 to 200 nm, more preferably 10 to 100 nm, still more preferably 10 to 50 nm. As these inorganic compounds, natural substances may be used, or those synthesized by the method described in Japanese Patent Laid-open Publication No. 2000-128520 or the like may be used.

The inorganic compound contained in the base material film of the present invention may have any of the spherical (granular), needlelike (fibrous) and tabular shapes defined according to the aforementioned classification. The inorganic compound used in the present invention is preferably carbon nanotube, vanadium oxide, allophane or imogolite, more preferably allophane or imogolite.

When the inorganic compound has a tabular shape, it preferably consists of plates of inorganic compound having an average aspect ratio of 5 to 10,000. With such an aspect ratio, the plates should have an average thickness of 2.5 nm or less, preferably 0.4 to 2.5 nm, more preferably 0.5 to 2 nm, and a maximum thickness of 10 nm. Average length (average length in the longitudinal direction) of such plates is preferably 2 nm to 1 μm. As these tabular inorganic compounds, natural substances may be used, or synthesized products may be used. Examples of the tabular inorganic compound include, for example, layered silicates, layered oxides and so forth.

Examples of the layered silicate contained in the tabular inorganic compounds include, for example, smectic clay minerals, vermiculite clay minerals, mica, montmorillonite, nontronite, beidellite, volkonskoite, hectorite, stevensite, halloysite, saponite, sauconite, magadite, bentonite, kenyaite and so forth. As the layered oxide, K₄Nb₆O₁₇, H₂Ti₄O₉, H₃Sb₃P₂O₁₄ and so forth can be used.

As the aforementioned tabular inorganic compound, commercial products may be used, or those synthesized according to the description of Revue de Chimie Minerale, No. 23, p. 766, 1986 or the like may be used.

As commercially available tabular inorganic compounds, Sumecton SA produced by Kunimine Industries, Kunipia F produced by Kunimine Industries, Somasif ME-100 produced by CO-OP Chemical, Lucentite SWN produced by CO-OP Chemical and so forth can be preferably used. Lucentite SWN produced by CO-OP Chemical is more preferred.

The spherical, needlelike or tabular inorganic compound used in the base material film of the present invention is used in a state of being dispersed in a resin. Therefore, surface of the inorganic compound preferably has a structure showing high affinity to polymers. For such a requirement, surface of the inorganic compound is preferably organophilized by the method disclosed in U.S. Pat. No. 2,531,365, the method disclosed in Japanese Patent Laid-open Publication No. 11-43319 or the like.

For the base material film of the present invention, silsesquioxanes can also be preferably used as the inorganic compound. Silsesquioxanes are compounds represented as [RSiO_{3/2}]. Silsesquioxanes are polysiloxanes usually synthesized by hydrolysis and polycondensation of RSiX₃ (R is hydrogen atom, an alkyl group, an alkenyl group, an aryl group, an aralkyl group or the like, and X is a halogen, an alkoxyl group or the like) type compounds, and as types of molecular arrangement thereof, amorphous structure, rudder structure, cage structure, partially cleaved structures thereof (structure where one silicon atom is removed from the cage structure or structure where a part of the silicon-oxygen bonds in the cage structure are cleaved) and so forth are known as typical examples. For the base material film of the present invention, cage type silsesquioxanes and those having partially cleaved structure thereof are particularly preferably used among the aforementioned silsesquioxanes.

Examples of the cage type silsesquioxanes include silsesquioxanes of the following formula (1) represented by the chemical formula [RSiO_{3/2}]₈, silsesquioxanes of the following formula (2) represented by the chemical formula [RSiO_{3/2}]₁₀, silsesquioxanes of the following formula (3) represented by the chemical formula [RSiO_{3/2}]₁₂, silsesquioxanes of the following formula (4) represented by the chemical formula [RSiO_{3/2}]₁₄, and silsesquioxanes of the following formula (5) represented by the chemical formula [RSiO_{3/2}]₁₆-n in the formula [RSiO_{3/2}]ₙ representing the cage type silsesquioxanes is an integer of 6 to 20, preferably 8, 10 or 12, and the silsesquioxane particularly preferably consists of silsesquioxane wherein n is 8 alone or a mixture of silsesquioxanes where n is 8, 10 or 12.

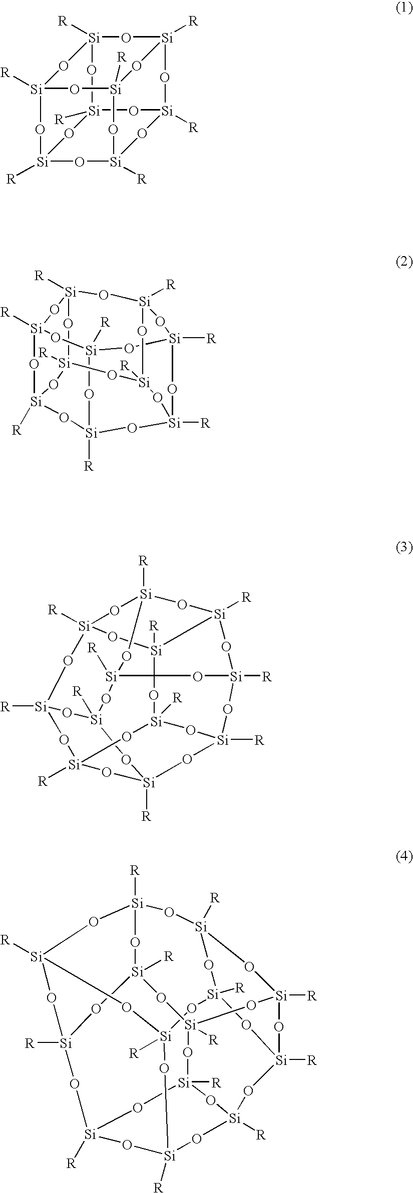

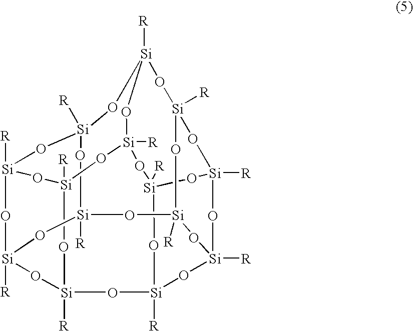

Cage type silsesquioxanes having a partially cleaved structure can also be preferably used as the inorganic compound contained in the base material film of the present invention. The cage type silsesquioxanes having a partially cleaved structure are compounds consisting of a cage type silsesquioxane in which a part of silicon-oxygen bonds are cleaved and represented as [RSiO_{3/2}]ₙ₋ₘ(O_{1/2}H)₂₊ₘ (n is an integer of 6 to 20, and m is 0 or 1). Preferred are trisilanol compounds of the following formula (6) represented by the chemical formula [RSiO_{3/2}]₇(O_{1/2}H)₃, silsesquioxanes of the following formula (7) represented by the chemical formula [RSiO_{3/2}]₈ (O_{1/2}H)₂, and silsesquioxanes of the following formula (8) represented by the chemical formula [RSiO_{3/2}]₈ (O_{1/2}H)₂, which correspond to the silsesquioxanes of the formula (1) in which a part of silicon-oxygen bonds are cleaved.

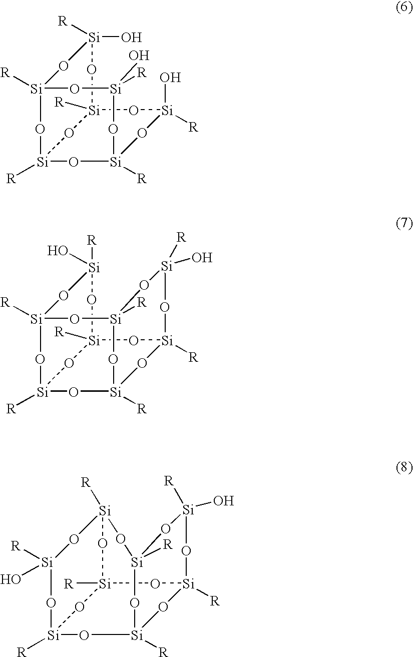

In the aforementioned formulas (1) to (8), R is hydrogen atom, a saturated hydrocarbon group having 1 to 20 carbon atoms, an alkenyl group having 2 to 20 carbon atoms, an aralkyl group having 7 to 20 carbon atoms or an aryl group having 6 to 20 carbon atoms.

Examples of the saturated hydrocarbon group having 1 to 20 carbon atoms include methyl group, ethyl group, n-propyl group, i-propyl group, butyl group (n-butyl group, i-butyl group, tert-butyl group, sec-butyl group etc.), pentyl group (n-pentyl group, i-pentyl group, neopentyl group, cyclopentyl group etc.), hexyl group (n-hexyl group, i-hexyl group, cyclohexyl group etc.), heptyl groups (n-heptyl group, i-heptyl group etc.), octyl group (n-octyl group, i-octyl group, tert-octyl group etc.), nonyl group (n-nonyl group, i-nonyl group etc.), decyl groups (n-decyl group, i-decyl group etc.), undecyl group (n-undecyl group, i-undecyl group etc.), dodecyl group (n-dodecyl group, i-dodecyl group etc.) and so forth. When the balance of melt flowability, fire retardancy and operativity at the time of molding is taken into consideration, it is preferably a saturated hydrocarbon having 1 to 16 carbon atoms, particularly preferably a saturated hydrocarbon having 1 to 12 carbon atoms.

As the alkenyl group having 2 to 20 carbon atoms, both of noncyclic alkenyl groups and cyclic alkenyl groups can be used. Examples include vinyl group, propenyl group, butenyl group, pentenyl group, hexenyl group, cyclohexenyl group, cyclohexenylethyl group, norbornenylethyl group, heptenyl group, octenyl group, nonenyl group, decenyl group, undecenyl group, dodecenyl group and so forth. As for the alkenyl group, when the balance of melt flowability, fire retardancy and operativity at the time of molding is taken into consideration, it is preferably an alkenyl group having 16 or less carbon atoms, particularly preferably an alkenyl group having 12 or less carbon atoms.

Examples of the aralkyl group having 7 to 20 carbon atoms include benzyl group, phenethyl group, which may be substituted with one or more alkyl group having 1 to 13 carbon atoms, preferably 1 to 8 carbon atoms, and so forth.

Examples of the aryl group having 6 to 20 carbon atoms include phenyl group, tolyl group, and phenyl group, tolyl group or xylyl group substituted with an alkyl group having 1 to 13 carbon atoms, preferably 1 to 8 carbon atoms, and so forth.

As these cage type polysilsesquioxanes, compounds commercially available from Aldrich, Hybrid Plastic, Chisso Corp., AZmax. Co. and so forth can be used as they are, or compounds synthesized according to the description of Journal of American Chemical Society, vol. 111, p. 1741 (1989) or the like may be used.

The base material film used in the present invention preferably can also contain an inorganic compound having a negative coefficient of linear expansion. That is, by adding an inorganic compound having a negative coefficient of linear expansion to a resin of the base material film in the film of the present invention, thermal expansion can be suppressed as compared with the base material film consisting of the resin alone. This means that when the film of the present invention is used as a liquid crystal display substrate or organic EL substrate, thermal expansion behavior of the film can be similar to that of ITO or TFT, and therefore generation of curling or crack due to heating and cooling during the fabrication of ITO or TFT can be made more unlikely to occur. Moreover, in the present invention, with such a base material film, mechanical properties (tensile strength, elastic modulus, bending strength, processing dimensional stability, creep characteristic, wear resistance, surface hardness etc.), heat resistance, molding processability, fire retardancy and so forth can be improved compared with use of a base material film consisting of a resin alone.

In U.S. Pat. Nos. 5,322,559 and 5,514,559, it is reported that ZrW₂O₈, HfW₂O₈, Sc₂(WO₄)₃, BiCu₂VO₆, Sc₂(MoO₄)₃, ZrMo₂O₈, ZrV₂O₇, HfV₂O₇, HfVPO₇, ZrVPO₇ etc. have a negative coefficient of linear expansion, and these inorganic compounds can be preferably used in the present invention. Moreover, the glass ceramics having negative thermal expansion property disclosed in Japanese Patent Laid-open Publication No. 2001-172048, which comprise β-eucryptite, β-eucryptite solid solution, β-quartz and β-quartz solid solution as the main ingredients, Nb₂O₅, Nb₂O₅—TiO₂ described in Journal of Applied Physics, vol. 91, p. 5051 and so forth can also be preferably used in the present invention.

As the method for preparing microparticles of the inorganic compound, a known the method can be used. For example, it is described that inorganic microparticles can be obtained by using a pulverizing machine such as rolling mill, high speed revolution type grinder, ball mill, medium mixing mill and jet mill in “Biryushi Sekkei (Design of Microparticles)”, Chapter 7, Edited by Masumi Koishi, published by Kogyo Chosakai, 1987. In the present invention, it is desirable that the inorganic compound having a negative coefficient of linear expansion should be dispersed in the base material in a state of microparticles prepared by these methods.

When the inorganic compound having a negative coefficient of linear expansion is an inorganic oxide, it is also possible to synthesize it as microparticles by a sol-gel method utilizing a corresponding metal alkoxide as a starting material. For example, Nb₂O₅ microparticles can be obtained by a sol-gel reaction utilizing Nb (OEt)₅ as a starting material.

Because the inorganic compound used in the present invention is used in a state of being dispersed in a resin, it is preferably subjected to a surface treatment so that it should have affinity to polymers. Examples of surface treating agent used in the present invention include silane type surface treating agents, titanate type surface treating agents, alumina type surface treating agents and so forth. In view of reactivity, handling property, cost and stability, silane type surface treating agents are preferably used.

Preferred examples of the aforementioned silane type surface treating agents include silane coupling agents represented by the following formula (A).

YₙSiX₄₋ₙ (A)

In the formula (A), X is a hydrolysable group or hydroxyl group, and when two or more of X exist, they may identical or different. Y is a hydrocarbon group having 1 to 30 carbon atoms, which may be substituted, and it may be substituted with at least one kind of group selected from the group consisting of, for example, epoxy group, amino group, amido group, carboxyl group, mercapto group, hydroxyl group, a halogen atom, an acyloxy group having 2 to 8 carbon atoms, a carboxyl group etherified with an alkyl alcohol having 1 to 22 carbon atoms and a hydroxyl group etherified with an alkyl alcohol having 1 to 22 carbon atoms. When two or more of Y exist, they may be identical or different. n is an integer of 1 to 3.

Examples of the hydrolysable group X in the formula (A) include, for example, an alkoxyl group having 1 to 8 carbon atoms (e.g., methoxy group, ethoxy group, propoxy group, butoxy group etc.), an alkenyloxy group having 3 to 8 carbon atoms (e.g., isopropenoxy group, 1-ethyl-2-methyl vinyl oxime group etc.), a ketoxime group having 3 to 8 carbon atoms (e.g., dimethyl ketoxime group, methyl ethyl ketoxime group etc.), an acyloxy group having 2 to 8 carbon atoms (e.g., acetoxy group, propionoxy group, butyloyloxy group, benzoyl oxime group etc.), an amino group (e.g., dimethylamino group, diethylamino group etc.), an aminoxy group (e.g., dimethylaminoxy group, diethylaminoxy group etc.), an amido group (e.g., N-methylacetamido group, N-ethylacetamido group, N-methylbenzamido group etc.), a halogen atom (e.g., chlorine atom, bromine atom etc.) and so forth. Among these, an alkoxyl group having 1 to 4 carbon atoms and chlorine atom are preferred in view of reactivity.

Examples of the hydrocarbon group Y in the formula (A) include an unsubstituted alkyl group having 1 to 25 carbon atoms (e.g., methyl group, ethyl group, propyl group, isopropyl group, butyl group, pentyl group, hexyl group, octyl group, decyl group, dodecyl group, tetradecyl group, hexadecyl group, octadecyl group, eicosyl group, docosyl group etc.), an unsubstituted alkenyl group having 2 to 25 carbon atoms (e.g., vinyl group, 1-propenyl group, 1-butenyl group, 1-hexenyl group, 2-hexenyl group, 1-octenyl group, 3-octenyl group, cyclohexenyl group etc.), an unsubstituted aromatic group having 6 to 25 carbon atoms (e.g., phenyl group, naphthyl group etc.), an unsubstituted aralkyl group having 7 to 25 carbon atoms (benzyl group, phenethyl group etc.), an unsubstituted cycloalkyl group having 6 to 25 carbon atoms (cyclohexyl group, cyclooctyl group etc.), a substituted alkyl group having 1 to 25 carbon atoms, (examples of substituent include, for example, epoxy group, amino group, carboxyl group, mercapto group, hydroxyl group, a halogen atom, an acyloxy group having 2 to 8 carbon atoms, a carboxyl group etherified with an alkyl alcohol having 1 to 10 carbon atoms, a hydroxyl group etherified with an alkyl alcohol having 1 to 10 carbon atoms etc., henceforth simply referred to as “substituent”) (e.g., γ-(2-aminoethyl)aminopropyl group, γ-glycidoxypropyl group, γ-mercaptopropyl group, γ-chloropropyl group, γ-aminopropyl group etc.), a substituted alkenyl group having 2 to 25 carbon atoms (e.g., γ-methacryloxypropyl group, 4-methyl-4-amino-1-hexenyl group etc.), a substituted alkynyl group having 2 to 25 carbon atoms (e.g., γ-aminopropynyl group etc.), a substituted aromatic group having 6 to 25 carbon atoms (e.g., γ-anilinopropyl group etc.), a substituted aralkyl group having 7 to 25 carbon atoms (e.g., N-β-(N-vinylbenzylaminoethyl)-γ-aminopropyl group etc.), a substituted cycloalkyl group having 6 to 25 carbon atoms (e.g., 2-(3,4-epoxycyclohexyl)ethyl group etc.) and so forth. Among these, an unsubstituted alkyl group having 1 to 25 carbon atoms (e.g., methyl group, ethyl group, propyl group, isopropyl group, butyl group, pentyl group, hexyl group, octyl group, decyl group, dodecyl group, tetradecyl group, hexadecyl group, octadecyl group, eicosyl group, docosyl group etc.) is preferred.

X, Y and n in the formula (A) have the meanings as defined above, and specific examples of silane type surface treating agents such as silane type coupling agents represented by the formula (A) including a combination of the groups of X and Y and n defined above include, for example, those in which Y has a polymethylene chain such as decyltrimethoxysilane and octadecyldimethylmethoxysilane, those in which Y is a lower alkyl group such as methyltrimethoxysilane and trimethylethoxysilane, those in which Y has an unsaturated hydrocarbon group such as 2-hexenyltrimethoxysilane, those in which Y has a side chain such as 2-ethylhexyltrimethoxysilane, those in which Y has phenyl group such as phenyltriethoxysilane, those in which Y has an aralkyl group such as 3-β-naphthylpropyltrimethoxysilane, those in which Y has phenylene group such as p-vinylbenzyltrimethoxysilane, those in which Y has vinyl group such as vinyltrimethoxysilane, vinyltrichlorosilane and vinyltriacetoxysilane, those in which Y has an ester group such as γ-methacryloxypropyltrimethoxysilane, those in which Y has an ether group such as γ-polyoxyethylenepropyltrimethoxysilane and 2-ethoxyethyltrimethoxysilane, those in which Y has epoxy group such as γ-glycidoxypropyltrimethoxysilane, those in which Y has amino group such as γ-aminopropyltrimethoxysilane, γ-(2-aminoethyl)aminopropyltrimethoxysilane and γ-anilinopropyltrimethoxysilane, those in which Y has carbonyl group such as γ-ureidopropyltriethoxy silane, those in which Y has mercapto group such as γ-mercaptopropyltrimethoxysilane, those in which Y has a halogen such as γ-chloropropyltriethoxysilane, and those in which Y has hydroxyl group such as N,N-di(2-hydroxyethyl)amino-3-propyltriethoxysilane.

More preferred examples of the aforementioned silane type surface treating agents include silane coupling agents represented by the following formula (B).

Y₃SiX (B)

In the formula (B), X is a hydrolysable group or hydroxyl group. Y is a hydrocarbon group having 1 to 30 carbon atoms, which may be substituted, and it may be substituted with at least one kind of group selected from the group consisting of, for example, epoxy group, amino group, amido group, carboxyl group, mercapto group, hydroxyl group, a halogen atom, an acyloxy group having 2 to 8 carbon atoms, a carboxyl group etherified with an alkyl alcohol having 1 to 22 carbon atoms, and a hydroxyl group etherified with an alkyl alcohol having 1 to 22 carbon atoms. When two or more of Y exist, they may be identical or different. Further preferred are those of the formula (B) wherein X is either methoxy group, ethoxy group or chlorine atom, and Y is a straight alkyl group, and the most preferred is trimethylmethoxysilane or octadecyldimethylchlorosilane. These silane type surface treating agents may be used as each kind alone, or may be used as a combination of two or more kinds of them.

As the method for covalently bonding the surface treating agent to surfaces of the inorganic microparticles, a known method may be used. Specifically, the inorganic microparticles can be suspended in a solvent, then added with a surface treating agent and reacted at room temperature or with heating to covalently bonding the surface treating agent to the surfaces of inorganic microparticles. Excessive surface treating agent not covalently bonding to the inorganic microparticles can be removed by evaporation under reduced pressure or washing with a good solvent for the surface treating agent such as ethyl acetate, tetrahydrofuran, chloroform and ethanol. Covalent bonds between the surface treating agent and the inorganic microparticles can be confirmed by, for example, measuring absorption bands originating in functional groups of the surface treating agent by infrared spectroscopy (IR).

In the present invention, if content of the inorganic compound contained in the base material film is relatively small with respect to the weight of the polymer, the aforementioned advantages of the inorganic compound may not be obtained in may cases. On the other hand, if the content becomes relatively large with respect to the weight of the polymer, brittleness of the obtained base material film tends to become significant, although the aforementioned advantages of the inorganic compound also become significant. Therefore, the addition ratio of the inorganic compound is preferably 0.1 to 50 weight %, more preferably 5 to 25 weight %, still more preferably 10 to 20 weight %, with respect to the total weight of the base material film (polymer+inorganic compound).

### (Polymer Used for Base Material Film)

The material of the base material film used for the film of the present invention is not particularly limited so long as a material that can hold the inorganic layer and organic layer when it is formed in the shape of film and has a glass transition temperature (henceforth referred to as “Tg”) of 250° C. or higher, more preferably 300° C. or higher, still more preferably 350° C. or higher, is chosen, and a material usable as a base material for barrier films can be suitably selected.

Examples of such material include, for example, thermoplastic resins having Tg of 250° C. or higher such as methacrylic resins, methacrylic acid/maleic acid copolymers, polystyrenes, transparent fluoro-resins, polyimide resins, fluorinated polyimide resins, polyamide resins, polyamidimide resins, polyetherimide resins, cellulose acylate resins, polyurethane resins, polyether ether ketone resins, polycarbonate resins, alicyclic polyolefin resins, polyarylate resins, polyether sulphone resins, polysulfone resins, cycloolefin copolymers, fluorene ring-modified polycarbonate resins, alicyclic ring-modified polycarbonate resins and acryloyl compounds.

Preferred examples of the material used for the base material film of the present invention include polymers having a spiro structure represented by the following formula (I) and polymers having a cardo structure represented by the following formula (II). These polymers are compounds showing high heat resistance, high elastic modulus and high tension fracture stress and suitable as substrate materials for organic EL devices and so forth, for which various heating operations are required in the production processes and performance of being unlikely to fracture even when the devices are bent is required.

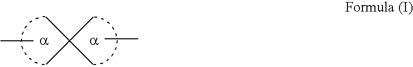

In the formula (I), the rings a represent a monocyclic or polycyclic ring, and two of the rings are bound via a Spiro bond.

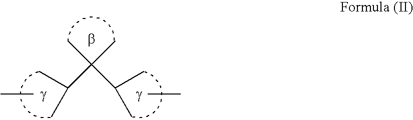

In the formula (II), the ring β and the rings γ independently represent a monocyclic or polycyclic ring, and two of the rings γ may be identical or different and bond to one quaternary carbon atom in the ring β.

Preferred examples of the polymers having a spiro structure represented by the formula (I) include polymers containing a spirobiindane structure represented by the following formula (III) in repeating units, polymers containing a spirobichroman structure represented by the following formula (IV) in repeating units, and polymers containing a spirobibenzofuran structure represented by the following formula (V) in repeating units.

Preferred examples of the polymers having a cardo structure represented by the formula (II) include polymers containing a fluorene structure represented by the following formula (VI) in repeating units.

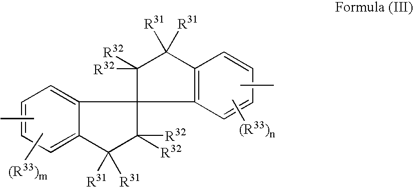

In the formula (III), R³¹, R³² and R³³ each independently represent hydrogen atom or a substituent. Groups of each type may bond to each other to form a ring. m and n represent an integer of 1 to 3. Preferred examples of the substituent include a halogen atom, an alkyl group and an aryl group. More preferred examples of R³¹ and R³² are hydrogen atom, methyl group and phenyl group, and more preferred examples of R³³ are hydrogen atom, chlorine atom, bromine atom, methyl group, isopropyl group, tert-butyl group and phenyl group.

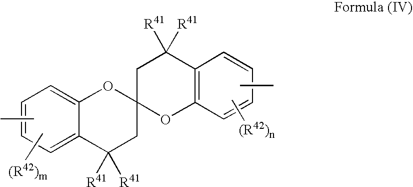

In the formula (IV), R⁴¹ and R⁴² each independently represent hydrogen atom or a substituent. Groups of each type may bond to each other to form a ring. m and n represent an integer of 1 to 3. Preferred examples of the substituent include a halogen atom, an alkyl group and an aryl group. More preferred examples of R⁴¹ are hydrogen atom, methyl group and phenyl group, and more preferred examples of R⁴² are hydrogen atom, chlorine atom, bromine atom, methyl group, isopropyl group, tert-butyl group and phenyl group.

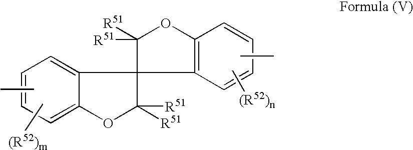

In the formula (V), R⁵¹ and R⁵² each independently represent hydrogen atom or a substituent. Groups of each type may bond to each other to form a ring. m and n represent an integer of 1 to 3. Preferred examples of the substituent include a halogen atom, an alkyl group and an aryl group. More preferred examples of R⁵¹ are hydrogen atom, methyl group and phenyl group, and more preferred examples of R⁵² are hydrogen atom, chlorine atom, bromine atom, methyl group, isopropyl group, tert-butyl group and phenyl group.

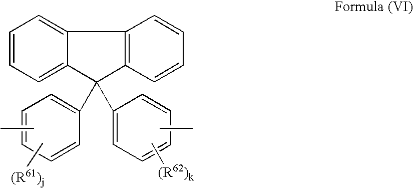

In the formula (VI), R⁶¹ and R⁶² each independently represent hydrogen atom or a substituent. Groups of each type may bond to each other to form a ring. j and k represent an integer of 1 to 4. Preferred examples of the substituent include a halogen atom, an alkyl group and an aryl group. More preferred examples of R⁶¹ and R⁶² are hydrogen atom, chlorine atom, bromine atom, methyl group, isopropyl group, tert-butyl group and phenyl group.

The polymers containing a structure represented by any one of the formulas (III) to (VI) in repeating units may be polymers formed with various bonding schemes such as polycarbonates, polyesters, polyamides, polyimides and polyurethanes. However, the polymers are preferably polycarbonates, polyesters or polyurethane derived from a bisphenol compound and having a structure represented by any one of the formulas (III) to (VI) in view of optical transparency. Among these, aromatic polyesters are particularly preferred in view of heat resistance.

Preferred specific examples of the polymers having a structure represented by the formula (I) or formula (II) are shown below. However, the present invention is not limited to these.

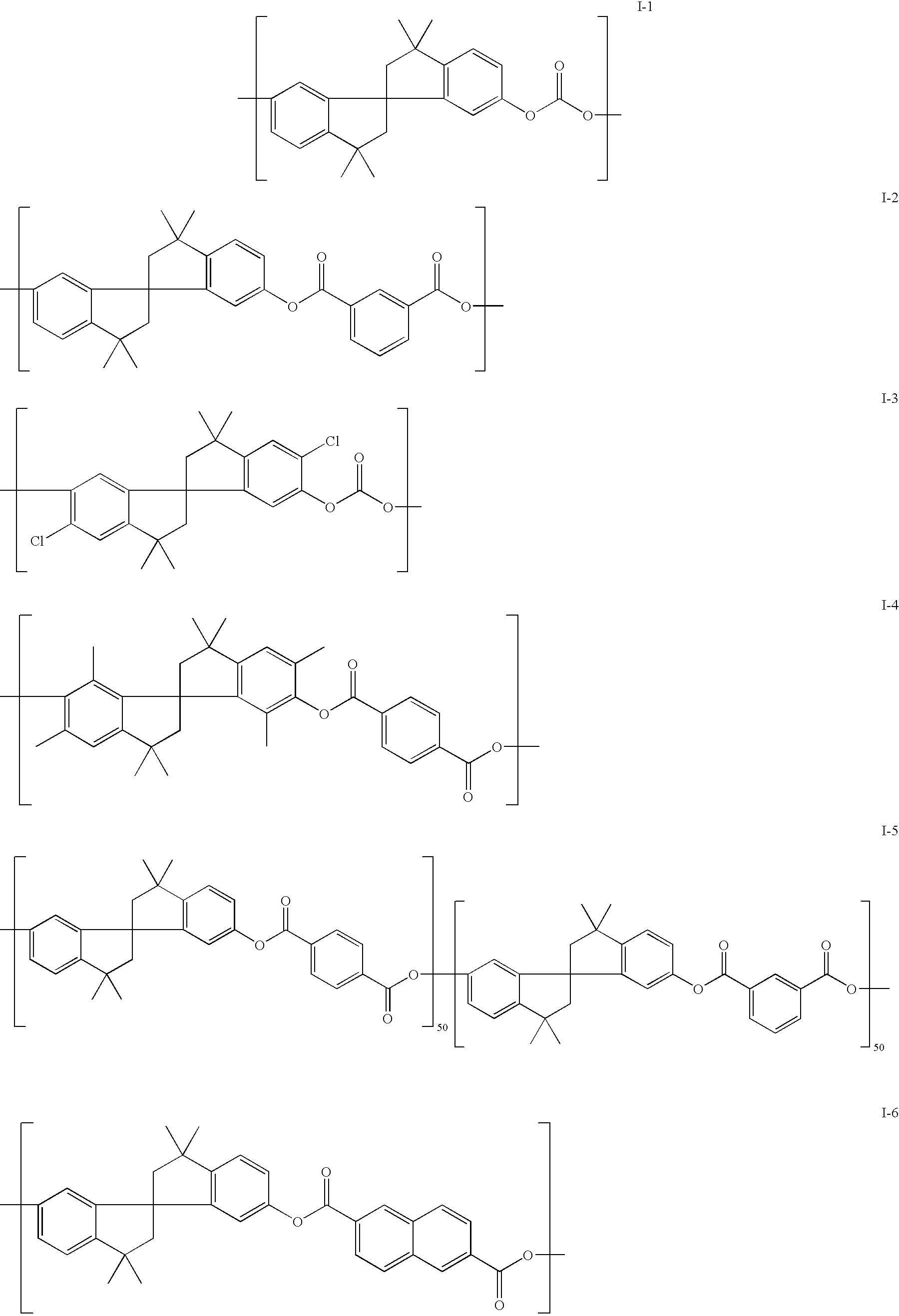

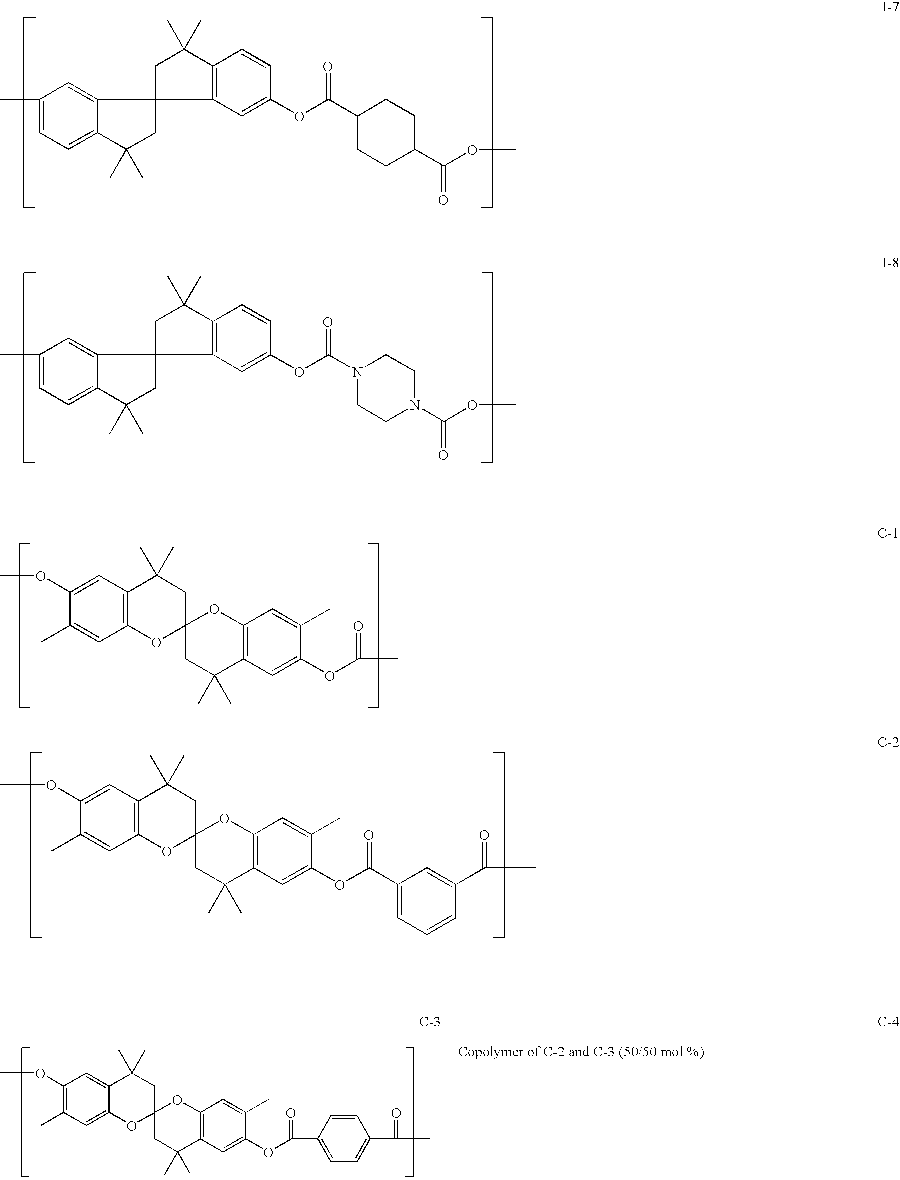

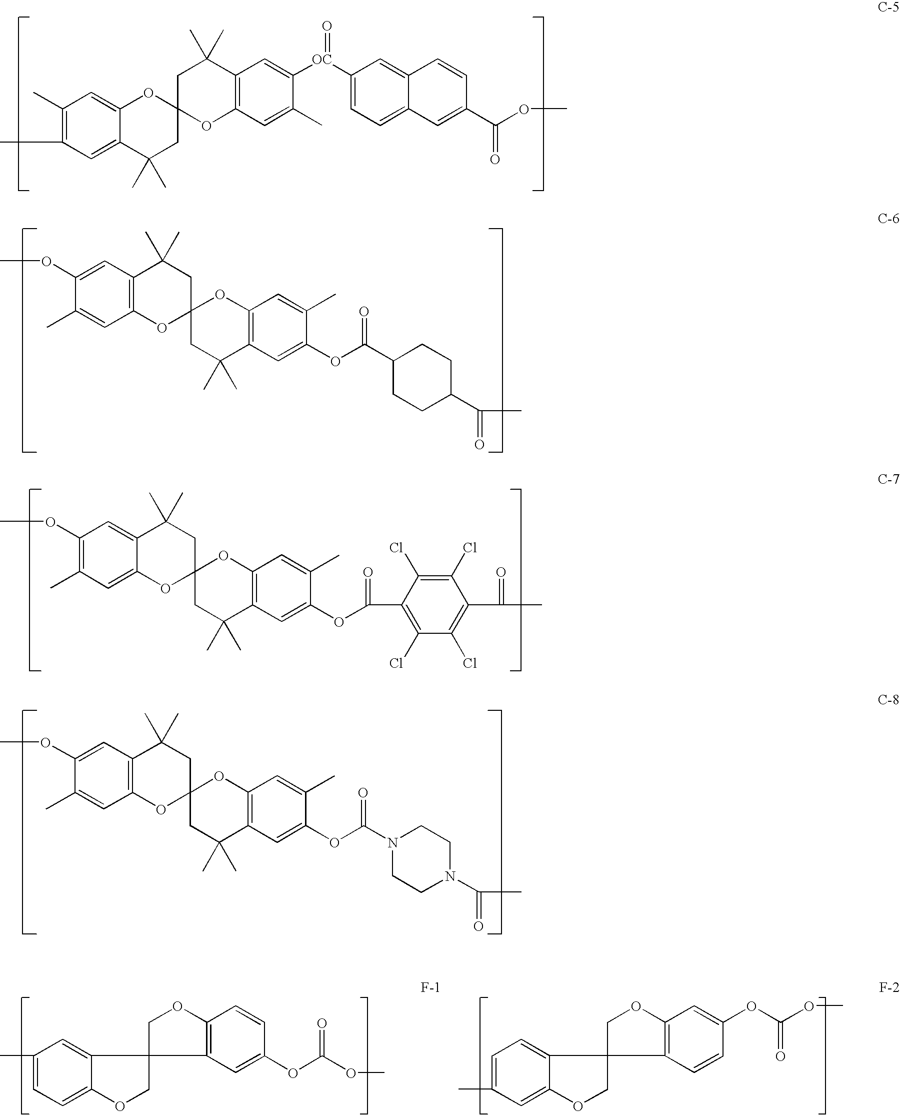

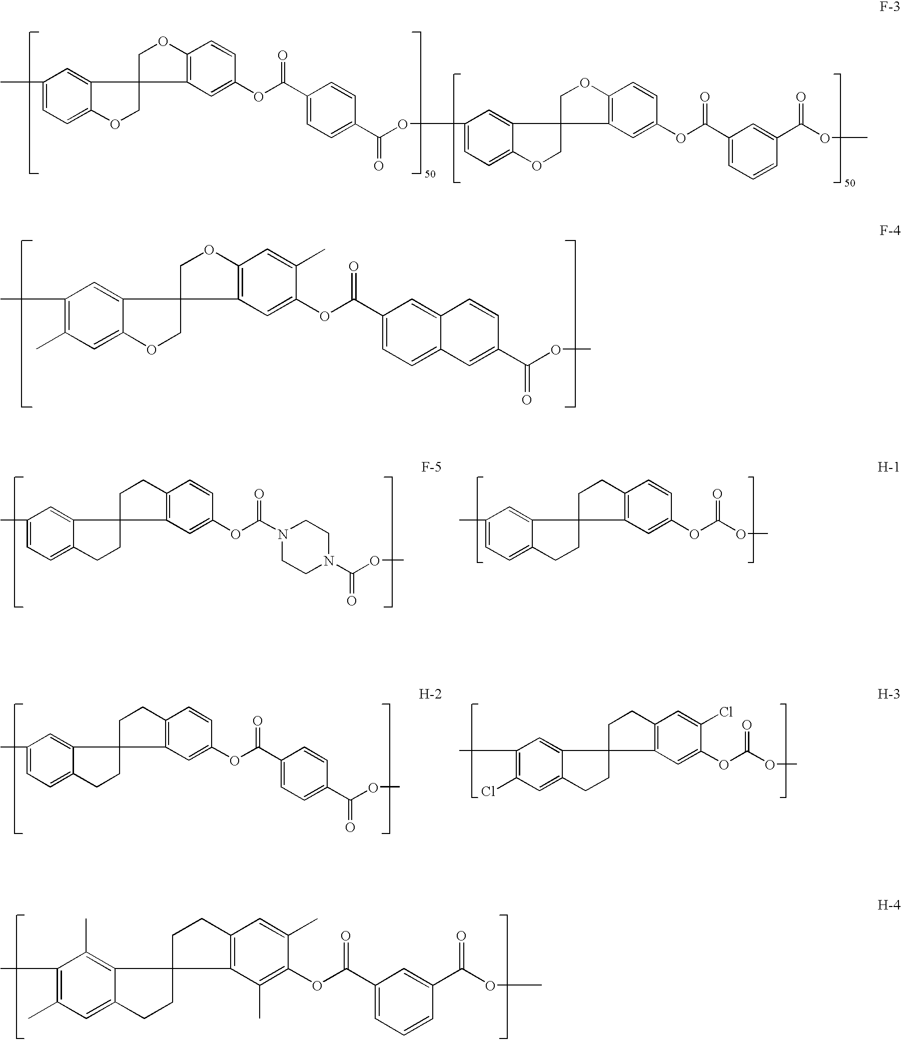

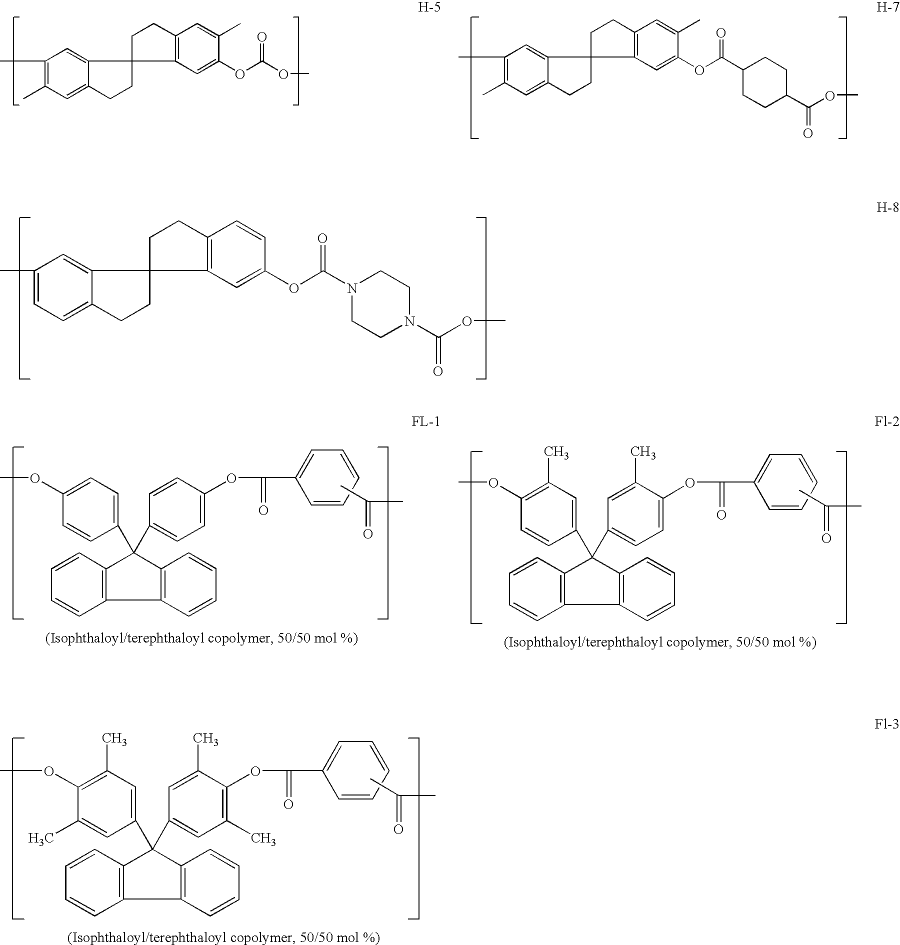

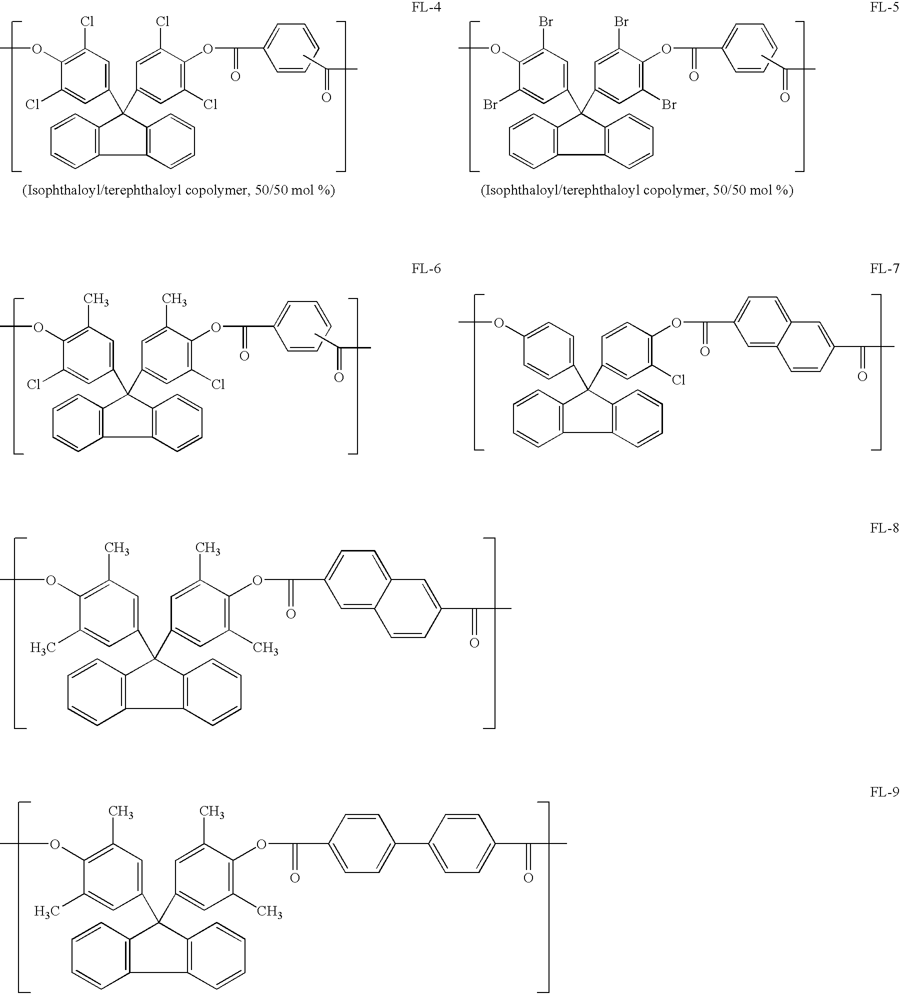

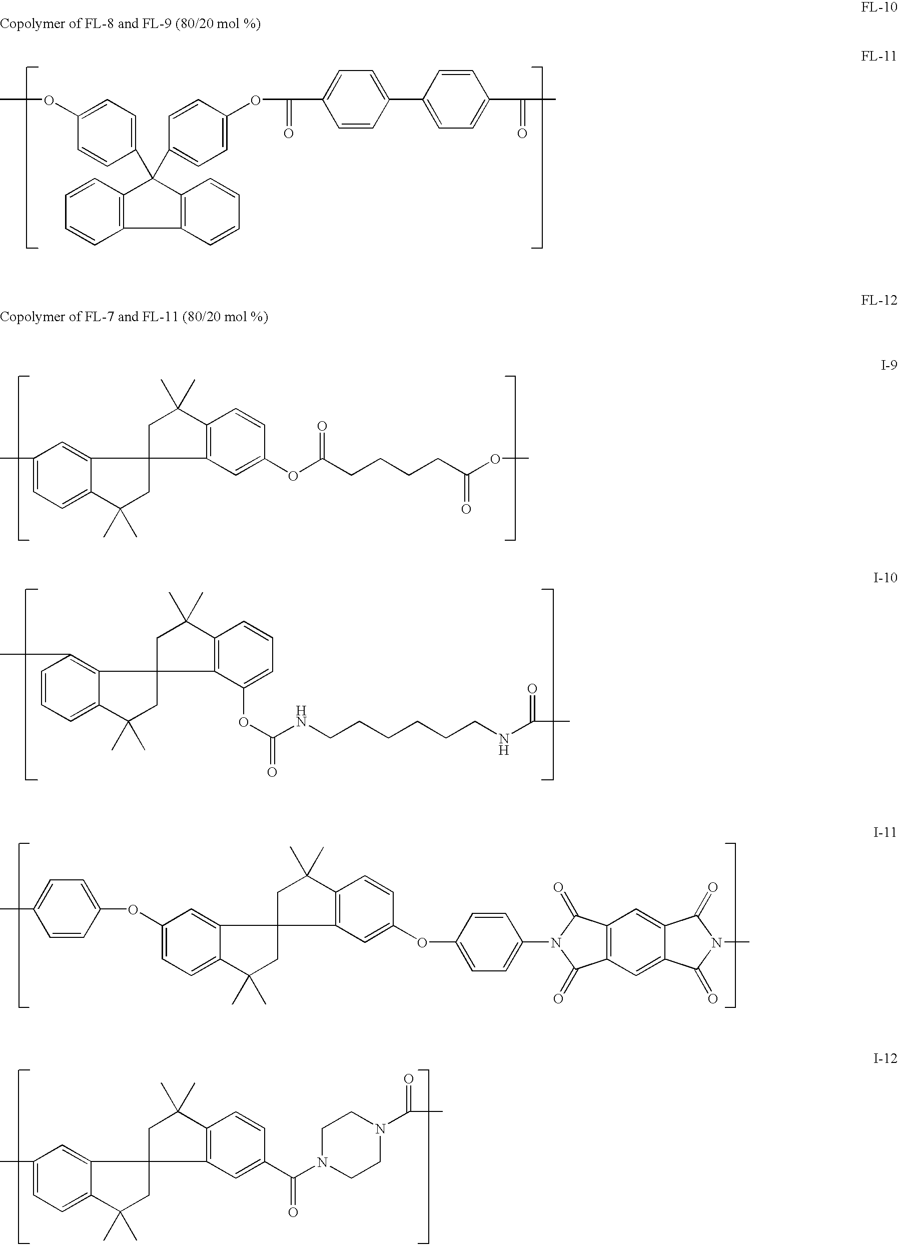

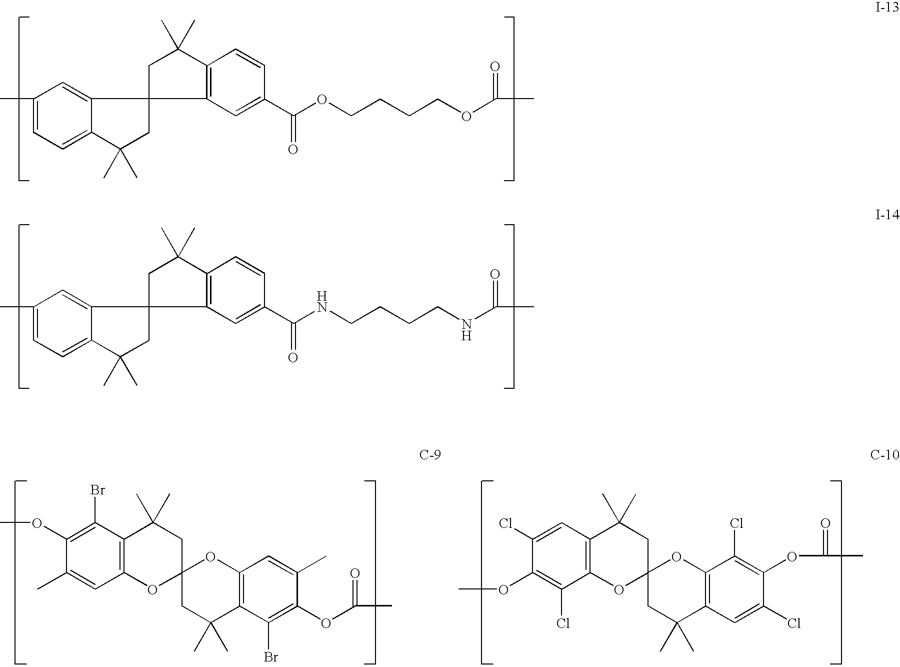

The polymers having a structure represented by the formula (I) or formula (II) used in the present invention may be used independently, and may be used as a mixture of two or more kinds of them. Moreover, they may be homopolymers or copolymers comprising a combination of two or more kinds of the structures. When a copolymer is used, a known repeating unit not containing a structure represented by the formula (I) or (II) in the repeating unit may be copolymerized within such a degree that the advantages of the present invention should not be degraded. Copolymers more often have improved solubility and transparency compared with homopolymers, and such copolymers can be preferably used.

The polymers having a structure represented by the formula (I) or formula (II) used for the present invention preferably have a molecular weight of 10,000 to 500,000, more preferably 20,000 to 300,000, particularly preferably 30,000 to 200,000, in terms of weight average molecular weight. If the weight average molecular weight is 10,000 or more, a film can be easily formed. On the other hand, if the weight average molecular weight is 500,000 or less, the molecular weight is easily controlled during the synthesis, favorable viscosity of a solution can be obtained, and thus handling is easy. The molecular weight may be tentatively determined on the basis of corresponding viscosity.

In the present invention, as the material used for the base material film, curable resins (crosslinkable resins) having superior solvent resistance, heat resistance and so forth may also be used besides the aforementioned polymers, so long as a material having Tg of 250° C. or higher is chosen. As for the types of the curable resins, both of thermosetting resins and radiation curable resins can be used, and those of known types can be used without particular limitations. Examples of the thermosetting resins include phenol resins, urea resins, melamine resins, unsaturated polyester resins, epoxy resins, silicone resins, diallyl phthalate resins, furan resins, bismaleimide resins, cyanate resins and so forth.

As for the method for crosslinking the aforementioned curable resins, any reactions that form a covalent bond may be used without any particular limitation, and systems in which the reactions proceed at room temperature, such as those utilizing a polyhydric alcohol compound and a polyisocyanate compound to form urethane bonds, can also be used without any particular limitation. However, such systems often have a problem concerning the pot life before the film formation, and therefore such systems are usually used as two-pack systems, in which, for example, a polyisocyanate compound is added immediately before the film formation. On the other hand, if a one-pack system is used, it is effective to protect functional groups to be involved in the crosslinking reaction, and such systems are marketed as blocked type curing agents.

Known as the marketed blocked type curing agents are B-882N produced by Mitsui Takeda Chemicals, Inc., Coronate 2513 produced by NIPPON POLYURETHANE INDUSTRY CO., LTD. (these are blocked polyisocyanates), Cymel 303 produced by Mitsui-Cytec Ltd. (methylated melamine resin) and so forth. Moreover, blocked carboxylic acids, which are protected polycarboxylic acids usable as curing agents of epoxy resins, such as B-1 mentioned below, are also known.

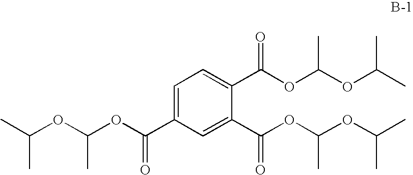

The radiation curable resins are roughly classified into radical curable resins and cationic curable resins. As a curable component of the radical curable resins, a compound having two or more radically polymerizable groups in the molecule is used, and as typical examples, compounds having 2 to 6 acrylic acid ester groups in the molecule called polyfunctional acrylate monomers, and compounds having two or more acrylic acid ester groups in the molecule called urethane acrylates, polyester acrylates, and epoxy acrylates are used.

Typical examples of the method for curing radical curable resins include a method of irradiating an electron ray and a method of irradiating an ultraviolet ray. In the method of irradiating an ultraviolet ray, a polymerization initiator that generates a radical by ultraviolet irradiation is usually added. If a polymerization initiator that generates a radical by heating is added, the resins can also be used as thermosetting resins.

As a curable component of the cationic curable resins, a compound having two or more cationic polymerizable groups in the molecule is used. Typical examples of the curing method include a method of adding a photoacid generator that generates an acid by irradiation of an ultraviolet ray and irradiating an ultraviolet ray to attain curing. Examples of the cationic polymerizable compound include compounds containing a ring opening-polymerizable group such as epoxy group and compounds containing a vinyl ether group.

For the base material film used in the present invention, a mixture of two or more kinds of resins selected from each type of the aforementioned thermosetting resins and radiation curable resins may be used, and a thermosetting resin and a radiation curable resin may be used together. Further, a mixture of a curable resin (crosslinkable resin) and a resin not having a crosslinkable group may also be used.

The aforementioned curable resin (crosslinkable resin) is preferably mixed in the base material film used in the present invention, because solvent resistance, heat resistance, optical characteristics and toughness of the base material film can be thereby obtained. Moreover, it is also possible to introduce crosslinkable groups into a resin used for the base material film, and such a resin may have the crosslinkable group at any of end of polymer main chain, positions in polymer side chain and polymer main chain. When such a resin is used, the base material film may be prepared without using the aforementioned commonly used crosslinkable resin together.

When the gas barrier laminate film of the present invention is used for liquid crystal displays and so forth, it is preferable to use an amorphous polymer as the resin used in order to attain optical uniformity. Furthermore, for the purpose of controlling retardation (Re) and wavelength dispersion thereof, polymers having positive and negative intrinsic birefringences may be combined, or a resin showing a larger (or smaller) wavelength dispersion may be combined.

In the present invention, a laminate of different resins or the like may be preferably used as the base material film in order to control retardation (Re) or improve gas permeability and mechanical characteristics. No particular limitation is imposed on preferred combinations of different resins, and any combinations of the aforementioned resins can be used.

The base material film used in the present invention may be contain a resin property modifier such as plasticizers, dyes and pigments, antistatic agents, ultraviolet absorbers, antioxidants, inorganic microparticles, release accelerators, leveling agents, inorganic layered silicate compounds and lubricants as required in such a degree that the advantages of the present invention are not degraded.

The base material film used in the present invention may be stretched. Stretching provides advantages of improvement of mechanical strengths of the film such as anti-folding strength, and thus provides improvement of handling property of the base material film. In particular, a base material film having an orientation release stress (ASTM D1504, henceforth abbreviated as “ORS”) of 0.3 to 3 GPa along the stretching direction is preferred, because mechanical strength of such a base material film is improved. ORS is internal stress present in a stretched film or sheet generated by stretching.

Known methods can be used as the stretching method, and the stretching can be performed by, for example, the monoaxial stretching method by roller, monoaxial stretching method by tenter, simultaneous biaxial stretching method, sequential biaxial stretching method or inflation method at a temperature of from a temperature higher than Tg of the resin by 10° C. to a temperature higher than Tg by 50° C. The stretching ratio is preferably 1.1 to 3.5 times.

Although the thickness of the base material film used in the present invention is not particularly limited, it is preferably 30 to 700 μm, more preferably 40 to 200 μm, still more preferably 50 to 150 μm. The haze of the base material film is preferably 3% or less, more preferably 2% or less, still more preferably 1% or less. Further, the total light transmission of the base material film is preferably 70% or more, more preferably 80% or more, still more preferably 90% or more.

Hereafter, production method of the base material film used in the present invention will be explained.

The base material film used in the present invention can be produced by several kinds of techniques. Specific examples include a method of preparing a base material film by dissolving a resin and an inorganic compound in a common solvent to obtain a solution, then coating and drying the solution, a method of preparing a base material film by adding an inorganic compound to a resin in a melted state, kneading the mixture and then forming a film from the mixture using an fusion extruder, a method of preparing a base material film by reacting a precursor of inorganic compound in a resin solution, then coating and drying the solution, a method of preparing a base material film by forming a uniform solution of a resin and a precursor of inorganic compound, then coating and drying the solution to form a film and produce an inorganic compound by a reaction in the film, and so forth.

The base material film used in the present invention is particularly preferably prepared by obtaining a metal oxide in a resin solution through hydrolysis and polycondensation reaction based on a sol-gel method, then coating and drying the solution containing the metal oxide. Hereafter, the production method of the base material film by a sol-gel method will be explained.

The hydrolysis and polycondensation based on a sol-gel method mean reactions in which a metal alkoxide type compound is reacted with water to convert alkoxyl groups into hydroxyl groups and the hydroxyl groups are simultaneously polycondensed so that the polymer having a hydroxy metal group should undergo a dehydration reaction or dealcoholation reaction to form three-dimensional crosslinkings with covalent bonds. As a starting material of the sol-gel reaction, not only a metal alkoxide type compound, but also a metal complex type compound can be used.

The metal alkoxide type compounds include, not only those in which groups bonding to a metal atom are constituted by only alkoxyl group or groups such as methoxide, ethoxide and isopropoxide, but also those in which a part of the groups are replaced with methyl group, ethyl group or the like such as monomethyl metal alkoxides and monoethyl metal alkoxides. Further, the metal complex type compounds include not only those in which groups bonding to a metal atom are constituted by only acetylacetone groups, but also those in which a part of the groups are replaced with methoxyl group, ethoxyl group or the like.

As the aforementioned metal, it is preferable to use a metal selected from the group consisting of Si, Ti, Al and Zr, and preferred compounds are tetramethoxysilane [Si(OCH₃)₄], tetraethoxysilane [Si(OC₂H₅)₄], methyltriethoxysilane [(CH₃)Si(OC₂H₅)₃], methyltrimethoxysilane [(CH₃)Si(OCH₃)₃], titanium tetraisopropoxide [Ti(O-iso-C₃H₇)₄], titanium acetylacetonate [Ti(CH₃COCHCOCH₃)₄], aluminum tri-sec-butoxide [Al(O-sec-C₄H₉)₄], zirconium n-butoxide [Zr(O-n-C₄H₉)₄], zirconium acetylacetonate [Zr(CH₃COCHCOCH₃)₄] and so forth. In view of reaction rate and cost, alkoxylsilanes are preferred, and tetraethoxysilane is particularly preferred.

Hereafter, the method for obtaining silicon oxide from an alkoxylsilane will be specifically explained.

### (a) Organosilane

The term “organosilane” means a silane compound having at least one functional group capable of providing a silanol by hydrolysis in the molecule, and it becomes hydrolysate and/or partial condensate obtained by hydrolysis and condensation in the metal oxide to serve as a binder of the metal oxide.

In general, compounds represented by the formula (R)₄Si are preferably used. In the formula, R represents a hydrocarbon group (for example, an alkyl group, an alkenyl group, an alkynyl group or an aryl group, these groups may be substituted), an alkoxyl group, an oxyacyl group or a halogen atom. Four of R in one molecule may be identical or different so long as they are within the above definition, and the combination of the groups may be freely selected. However, all four of them cannot be hydrocarbon groups, and the number of hydrocarbon group existing in one molecule is preferably 2 or less.

Among these organosilanes, alkoxysilanes are particularly preferably used. Examples include alkoxysilanes represented by the formula Si(OR¹)ₓ(R²)₄₋ₓ. In these alkoxysilanes, R¹ preferably represents an alkyl group having 1 to 5 carbon atoms or an acyl group having 1 to 4 carbon atoms. Examples include, for example, methyl group, ethyl group, n-propyl group, isopropyl group, n-butyl group, sec-butyl group, tert-butyl group, acetyl group and so forth. R² preferably represents an organic group having 1 to 10 carbon atoms. Examples include, for example, unsubstituted hydrocarbon groups such as methyl group, ethyl group, n-propyl group, isopropyl group, n-butyl group, tert-butyl group, n-hexyl group, cyclohexyl group, n-octyl group, tert-octyl group, n-decyl group, phenyl group, vinyl group and allyl group and substituted hydrocarbon groups such as γ-chloropropyl group, CF₃CH₂—, CF₃CH₂CH₂—, C₃F₇CH₂CH₂CH₂—, H(CF₂)₄—CH₂OCH₂CH₂CH₂—, γ-glycidoxypropyl group, γ-mercaptopropyl group, 3,4-epoxycyclohexylethyl group and γ-methacryloyloxypropyl group. x is preferably an integer of 2 to 4.

Specific examples of these alkoxysilanes are mentioned below.

Examples of the compounds where x=4 (henceforth referred to as “tetrafunctional organosilanes”) include tetramethoxysilane, tetraethoxysilane, tetra-n-propoxysilane, tetraisopropoxysilane, tetra-n-butoxysilane, tetraacetoxysilane and so forth.

Examples of the compounds where x=3 (henceforth referred to as “trifunctional organosilanes”) include methyltrimethoxysilane, methyltriethoxysilane, ethyltrimethoxysilane, ethyltriethoxysilane, n-propyltrimethoxysilane, n-propyltriethoxysilane, isopropyltrimethoxysilane, isopropyltriethoxysilane, γ-chloropropyltrimethoxysilane, γ-chloropropyltriethoxysilane, γ-glycidoxypropyltrimethoxysilane, γ-glycidoxypropyltriethoxysilane, γ-methacryloyloxypropyltrimethoxysilane, γ-mercaptopropyltriethoxysilane, phenyltrimethoxysilane, vinyltriethoxysilane, 3,4-epoxycyclohexylethyltrimethoxysilane, 3,4-epoxycyclohexylethyltriethoxysilane, CF₃CH₂CH₂Si(OCH₃)₃, C₂F₅CH₂CH₂Si (OCH₃)₃, C₂F₅OCH₂CH₂CH₂Si (OCH₃)₃, C₃F—OCH₂CH₂CH₂Si (OC₂H₅)₃, (CF₃)₂CHOCH₂CH₂CH₂Si (OCH₃)₃, C₄F₉ CH₂OCH₂CH₂CH₂Si (OCH₃)₃, H(CF₂)₄CH₂OCH₂CH₂CH₂Si (OCH₃)₃, 3-(perfluorocyclohexyloxy)propyltrimethoxysilane and so forth.

Examples of the compounds where x=2 (henceforth referred to as “bifunctional organosilanes”) include dimethyldimethoxysilane, dimethyldiethoxysilane, methylphenyldimethoxysilane, diethyldimethoxysilane, diethyldiethoxysilane, di-n-propyldimethoxysilane, di-n-propyldiethoxysilane, diisopropyldimethoxysilane, diisopropyldiethoxysilane, diphenyldimethoxysilane, divinyldiethoxysilane, (CF₃CH₂CH₂)₂Si (OCH₃)₂, (C₃F₇OCH₂CH₂CH₂)₂Si(OCH₃)₂, [H(CF₂)₆CH₂OCH₂CH₂CH₂]₂Si(OCH₃)₂, (C₂F₅CH₂CH₂)₂Si(OCH₃)₂ and so forth.

These organosilanes may be used as each kind alone, or may be used as a combination of two or more kinds of them.

In the present invention, the base material film can also be formed by coating a solution containing an organosilane prepared by the method described above as one of constituents and curing it. Moreover, to such a solution, the following various compounds can be added as required in addition the organosilanes.

(b) Hydrolysis and condensation catalyst (sol-gel catalyst)

### (c) Solvent

(d) Chelate ligand compound

### (e) Water

(f) Other additives

Hereafter, various additives that can be used together will be explained in detail.

### (b) Sol-Gel Catalyst

Various kinds of catalyst compounds can be used in usable sol solutions for the purpose of promoting hydrolysis and partial condensation reactions of organosilanes. The catalyst to be used is not particularly limited, and it can be used in an appropriate amount depending on the components of the sol solution used.

Generally effective catalysts are the compounds listed in (b1) to (b5) mentioned below, and a compound selected from them can be added in a required amount. Further, two or more kinds of compounds in these groups can be appropriately selected and used together, so long as the promotion effect of each compound is not inhibited.

(b1) Organic or Inorganic Acid

Examples of inorganic acid include hydrochloric acid, hydrogen bromide, hydrogen iodide, sulfuric acid, sulfurous acid, nitric acid, nitrous acid, phosphoric acid, phosphorous acid and so forth. Examples of organic compound include carboxylic acids (formic acid, acetic acid, propionic acid, butyric acid, succinic acid, cyclohexanecarboxylic acid, octanoic acid, maleic acid, 2-chloropropionic acid, cyanoacetic acid, trifluoroacetic acid, perfluorooctanoic acid, benzoic acid, pentafluorobenzoic acid, phthalic acid etc.), sulfonic acids (methanesulfonic acid, ethanesulfonic acid, trifluoromethanesulfonic acid, p-toluenesulfonic acid, pentafluorobenzenesulfonic acid etc.), phosphoric acids and phosphonic acids (phosphoric acid dimethyl ester, phenylphosphonic acid etc.), Lewis acids (boron trifluoride etherate, scandium triflate, alkyltitanic acid, aluminic acid etc.), heteropolyacids (phosphomolybdic acid, phosphotungstic acid etc.) and so forth.

(b2) Organic or Inorganic Base

Examples of inorganic base include sodium hydroxide, potassium hydroxide, calcium hydroxide, magnesium hydroxide, aluminum hydroxide, ammonia and so forth. Examples of organic base compound include amines (ethylenediamine, diethylenetriamine, triethylenetetramine, tetraethylenepentamine, triethylamine, dibutylamine, tetramethylethylenediamine, piperidine, piperazine, morpholine, ethanolamine, diazabicycloundecene, quinuclidine, aniline, pyridine etc.), phosphines (triphenylphosphine, trimethylphosphine etc.), and metal alkoxides (sodium methylate, potassium ethylate etc.).

(b3) Metal Chelate Compound

Metals having an alcohol represented by the formula R¹⁰OH (wherein R¹⁰ represents an alkyl group having 1 to 6 carbon atoms) and a diketone represented as R¹¹COCH₂COR¹² (wherein R¹¹ represents an alkyl group having 1 to 6 carbon atoms, and R¹² represents an alkyl group having 1 to 5 carbon atoms or an alkoxy group having 1 to 16 carbon atoms) as ligands can be suitably used without any particular limitation. Two or more kinds of metal chelate compounds may be used in combination so long as they are in this category.

Those having Al, Ti or Zr as the center metal are particularly preferred as the metal chelate compounds usable for the present invention. Those selected from a group of compounds represented by the formulas Zr(OR¹⁰) p(R¹¹COCHCOR¹²)ₚ₂, Ti(OR¹⁰)_{q1}(R¹¹COCHCOR²)_{q2} and Al(OR¹⁰)ᵣ₁(R¹¹COCHCOR¹²)ᵣ₂ are preferred, and they have an action of promoting the condensation reaction of the aforementioned component (a).

R¹⁰ and R¹¹ in the metal chelate compounds may be the same or different, and examples include, for example, an alkyl group having 1 to 6 carbon atoms, specifically, ethyl group, n-propyl group, isopropyl group, n-butyl group, sec-butyl group, tert-butyl group, n-pentyl group, phenyl group and so forth. R¹² represents, in addition to the aforementioned alkyl groups having 1 to 6 carbon atoms, an alkoxy group having 1 to 16 carbon atoms, for example, methoxy group, ethoxy group, n-propoxy group, isopropoxy group, n-butoxy group, sec-butoxy group, tert-butoxy group, lauryl group, stearyl group and so forth. In the metal chelate compounds, p1, p2, q1, q2, r1 and r2 are integers determined so as to obtain quadridentate or hexadentate coordination.

Specific examples of the metal chelate compounds include zirconium chelate compounds such as tri-n-butoxy(ethyl acetoacetate) zirconium, di-n-butoxy.bis(ethyl acetoacetate) zirconium, n-butoxy.tris(ethyl acetoacetate) zirconium, tetrakis(n-propyl acetoacetate) zirconium, tetrakis(acetyl acetoacetate) zirconium and tetrakis(ethyl acetoacetate) zirconium; titanium chelate compounds such as diisopropoxy.bis(ethyl acetoacetate) titanium, diisopropoxy.bis(acetyl acetate) titanium and diisopropoxy.bis(acetylacetone) titanium; aluminum chelate compounds such as diisopropoxy(ethyl acetoacetate) aluminum, diisopropoxy(acetyl acetonate) aluminum, isopropoxy.bis(ethyl acetoacetate) aluminum, isopropoxy.bis(acetyl acetonate) aluminum, tris(ethyl acetoacetate) aluminum, tris(acetyl acetonate) aluminum and monoacetyl acetonate.bis(ethyl acetoacetate) aluminum and so forth. Among these metal chelate compounds, tri-n-butoxy(ethyl acetoacetate) zirconium, diisopropoxy.bis(acetyl acetonate) titanium, diisopropoxy(ethyl acetoacetate) aluminum and tris(ethyl acetoacetate) aluminum are preferred. These metal chelate compounds can be used as each kind alone, or two or more kinds of them can be mixed and used in combination. Further, partial hydrolysates of these metal chelate compounds can also be used.

(b4) Organic Metal Compound

Although preferred organic metal compounds are not particularly limited, organic transition metal compounds are preferred because of their high activity. Among these, tin compounds are particularly preferred because of their favorable stability and activity. Specific examples of these compounds include organic tin compounds including carboxylic acid type organic tin compounds such as (C₄H₉)₂Sn(OCOC₁₁H₂₃)₂, (C₄H₉)₂Sn (OCOCH═CHCOOC₄H₉)₂, (C₈H₁₇)₂Sn (OCOC₁₁H₂₃)₂, (C₈H₁₇)₂Sn (OCOCH═CHCOOC₄H₉)₂ and Sn (OCCC₈H₁₇)₂; mercaptide type or sulfide type organic tin compounds such as (C₄H₉)₂Sn (SCH₂COOC₈H₁₇)₂, (C₈H₁₇)₂Sn (SCH₂CH₂COOC₈H₁₇)₂ and (C₈H₁₇)₂Sn (SCH₂COOC₁₂H₂₅)₂; (C₄H₉)₂SnO; (C₈H₁₇)₂SnO; reaction products of an organic tin oxide such as (C₄H₉)₂SnO and (C₈H₁₇)₂SnO and an ester compound such as ethyl silicate, dimethyl maleate, diethyl maleate and dioctyl phthalate, and so forth.

(b5) Metal Salt

As the metal salt, alkaline metal salts of organic acids (for example, sodium naphthenate, potassium naphthenate, sodium octanoate, sodium 2-ethylhexanoate, potassium laurate etc.) are preferably used. The ratio of the contained metal salt in a solution of the sol-gel catalyst compound is usually 0.01 to 50 weight %, preferably 0.1 to 50 weight %, more preferably 0.5 to 10 weight %, with respect to the organosilane, which is a raw material of the sol solution.

### (c) Solvent

The solvent allows all ingredients in the sol solution to be uniformly mixed, thereby adjusts solid matter in the sol-gel solution, enables use of various coating methods, and improves dispersion stability and storage stability of the solution. The solvent is not particularly limited so long as the aforementioned objects can be achieved.

Preferred examples of the solvent include, for example, water, alcohols, aromatic hydrocarbons, ethers, ketones, esters and mixed solvents of these.

Among these, examples of the alcohols include, for example, monohydric alcohols or dihydric alcohols, and as the monohydric alcohols, saturated aliphatic alcohols having 1 to 8 carbon atoms are preferred. Specific examples of the alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether, ethylene glycol acetate monoethyl ether and so forth.

Specific examples of aromatic hydrocarbons include benzene, toluene, xylene etc., specific examples of ethers include tetrahydrofuran, dioxane etc., specific examples of ketones include acetone, methyl ethyl ketone, methyl isobutyl ketone, diisobutyl ketone etc., and specific examples of esters include ethyl acetate, propyl acetate, butyl acetate, propylene carbonate etc. These organic solvents can be used as each kind alone, or two or more kinds of them can be mixed for use. The ratio of the organic solvent in the solution is not particularly limited, and they are used in such an amount that the total solid matter concentration can be adjusted depending on the purpose of use.

### (d) Chelate Ligand Compound

When a metal complex compound is used in the sol solution, it is also preferable to use a compound having an ability to coordinate a chelate in view of control of curing reaction rate or improvement of stability of the solution. Preferably used are β-diketones and/or β-ketoesters represented by the formula R¹⁰COCH₂COR¹¹, and they act as stability improver for the solution. That is, it is considered that these compounds coordinate the metal atom in the metal chelate compound (preferably, zirconium, titanium and/or aluminum compound) existing in the aforementioned reaction-accelerated solution to suppress the action of promoting the condensation reaction of the component (a) caused by the metal chelate compound and thus control the curing rate of the obtained film. R¹⁰ and R¹¹ have the same meanings as R¹⁰ and R¹¹ constituting the metal chelate compound. However, they do not need to have the same structure when they are used.

Specific examples of the β-diketones and/or β-ketoesters include acetylacetone, methyl acetoacetate, ethyl acetoacetate, n-propyl acetoacetate, isopropyl acetoacetate, n-butyl acetoacetate, sec-butyl acetoacetate, tert-butyl acetoacetate, 2,4-hexanedione, 2,4-heptanedione, 3,5-heptanedione, 2,4-octanedione, 2,4-nonanedione, 5-methylhexanedione and so forth. Among these, ethyl acetoacetate and acetylacetone are preferred, and acetylacetone is particularly preferred. One kind of these β-diketones and/or β-ketoesters can solely be used, or two or more kinds of these can be used as a mixture. These β-diketones and/or β-ketoesters are used in an amount of 2 moles or more, preferably 3 to 20 moles, with respect to 1 mole of the metal chelate compound. If the amount is less than 2 moles, the obtained composition shows poor storage stability.

### (e) Water

To the sol solution used in the present invention, water is preferably added for hydrolysis and condensation reactions of the component (a). The amount of water used is usually about 1.2 to 3.0 moles, preferably about 1.3 to 2.0 moles, with respect to 1 mole of the organosilane component (a). A sol solution preferably used in the present invention has a total solid content of 0.1 to 50 weight %, preferably 1 to 40 weight %, and if the total solid concentration exceeds 50 weight %, storage stability of the composition is unfavorably degraded.

### <Inorganic Layer>

Although the inorganic layer used in the present invention may be formed by any method so long as a method that can form an objective thin film is chosen, the sputtering method, vacuum deposition method, ion plating method, plasma CVD method and so forth are suitable, and the film formation can be attained by, for example, the methods described in Japanese Patent No. 3400324, Japanese Patent Laid-open Publication Nos. 2002-322561 and 2002-361774.

The material of the inorganic layer is not particularly limited, and for example, oxides, nitrides, oxynitrides etc. containing one or more kinds of elements selected from Si, Al, In, Sn, Zn, Ti, Cu, Ce, Ta and so forth can be used. The thickness of the inorganic layer is not also particularly limited. However, when it is too large, cracks may be generated by bending stress, and when it is too small, the film may be distributed in an island pattern. In the both cases, gas barrier property tends to be degraded. From this viewpoint, the thickness of each inorganic layer is preferably in the range of 5 to 1000 nm, more preferably 10 to 1000 nm, most preferably 10 to 200 nm. Further, when two or more inorganic layers are formed, they may have the same composition or different compositions.

In order to obtain both of water vapor barrier property and high transparency, it is preferable to use silicon oxide or silicon oxynitride for the inorganic layer. Silicon oxide is represented as SiOₓ. For example, when SiOₓ is used for the inorganic substance layer, x is desirably more than 1.6 and less then 1.9 (1.6<x<1.9) in order to obtain both of favorable water vapor barrier property and high light transmission. Silicon oxynitride is represented as SiOₓN_{y}. As for the ratio of x and y, when improvement of adhesion property is emphasized, an oxygen rich film is preferred, and thus it is preferred that x is more than 1 and less than 2, and y is more than 0 and less than 1 (1<x<2, 0<y<1). When improvement of water vapor barrier property is emphasized, a nitrogen rich film is preferred, and thus it is preferred that x is more than 0 and less than 0.8, and y is more than 0.8 and less than 1.3. (0<x<0.8, 0.8<y<1.3).

### <Organic Layer>

In the film of the present invention, the organic layer is preferably formed by curing radically polymerizable monomers having a vinyl group such as acrylate group or methacrylate group or cationic ring-open polymerizable monomers having a cyclic ether group such as epoxy group or oxetanyl group. These monomers may be monofunctional or polyfunctional depending on the use, and a mixture of monomers of different functionalities may be used.

Moreover, in the present invention, the organic layer may contain ingredients other than organic ingredients, i.e., inorganic substances, inorganic elements and metallic elements.

In the film of the present invention, although the thickness of the organic layer is not particularly limited, it is preferably in the range of 10 nm to 5000 nm, more preferably 10 nm to 2000 nm. If the thickness of the organic layer is 10 nm or larger, an organic layer having a uniform thickness can be formed, and thus structural defects of the inorganic layer can be efficiently filled with the organic layer. Therefore, the barrier property can be improved. Further, if the thickness of the organic layer is 5000 nm or smaller, cracks are not generated in the organic layer by an external force such as bending forth, and thus favorable gas barrier property can be maintained.

Examples of the method of forming the organic layer in the film of the present invention include an application method, vacuum film formation method and so forth. Although the vacuum film formation method is not particularly limited, vapor deposition, plasma CVD and so forth are preferred, and the resistance heating vapor deposition method is more preferred, in which film formation rate of organic monomers is easily controlled. Although the method of crosslinking the organic monomers of the present invention is not limited at all, crosslinking by means of irradiation of active energy ray such as electron ray or ultraviolet ray is preferred for the reasons that equipment therefor is easily disposed in a vacuum chamber, and it rapidly provides a higher molecular weight by crosslinking reactions.

When the organic layer is formed by an application method, conventionally used various application methods such as roller coating, photogravure coating, knife coating, dip coating, curtain flow coating, spray coating and bar coating can be used.

In the film of the present invention, the organic layer may be formed with an organic/inorganic hybrid material by also using hydrolysis and polycondensation of a metal alkoxide. As the metal alkoxide, alkoxysilanes and/or metal alkoxides other than alkoxysilane can be used. As the metal alkoxides other than alkoxysilane, zirconium alkoxides, titanium alkoxides, aluminum alkoxides and so forth are preferably used. Further, known inorganic fillers such as inorganic microparticles and layered silicates may be mixed in the organic layer as required.

In the formation step of the organic layer of the film of the present invention, an active energy ray used in the method of crosslinking the monomers of organic substance refers to radiation that can transmit energy with irradiation of ultraviolet ray, X-ray, electron ray, infrared ray, microwave or the like, and type and energy thereof can be arbitrarily chosen depending on the use.

In the formation of the organic layer according to the present invention, when a thermal polymerization initiator is used, the cationic ring-opening polymerization of the monomers is initiated, after a composition containing the monomers is coated or vapor-deposited, by contact heating using a heater or the like or irradiation heating using infrared rays, microwaves or the like. When a photopolymerization initiator is used, an activity energy ray is irradiated to initiate the polymerization. For irradiation of a ultraviolet ray, various light sources can be used, and for example, curing can be attained by the illuminating light of a mercury arc lamp, xenon arc lamp, fluorescence lamp, carbon arc lamp, tungsten-halogen radiation lamp, sunlight or the like. The irradiation intensity of ultraviolet ray is at least 0.01 J/cm². When the curing is attained continuously, it is preferable to set the irradiation rate so that the composition can be cured within 1 to 20 seconds. When the curing is attained with an electron ray, the curing is attained with an electron ray having an energy of 300 eV or less, or it is also possible to attain the curing instantly with irradiation of 1 to 5 Mrad.

In the film of the present invention, at least one laminate unit of the inorganic layer and the organic layer may be formed on one side of the base material film, or may be formed on the both sides. Moreover, two or more sets of the inorganic layers and organic layers may be repeatedly stacked adjacently to the aforementioned laminate unit. When such repeating units are formed, the number of the units should be 5 or less, preferably 2 or less, in view of the gas barrier property, production efficiency and so forth. Further, when the repeating units are formed, two or more of the inorganic layers and organic layers may have the same compositions or different compositions, respectively.

### <Functional Layer>

The film of the present invention can further have any of the following various functional layers in addition to the aforementioned inorganic layer and organic layer.

### (Transparent Conductive Layer)

As a transparent conductive layer that can be formed in the film of the present invention, known metal films and metal oxide films can be used. Metal oxide films are particularly preferred in view of transparency, conductivity and mechanical characteristics. Examples include, for example, metal oxide films such as those of indium oxide, cadmium oxide and tin oxide added with tin, tellurium, cadmium, molybdenum, tungsten, fluorine or the like as impurities, zinc oxide, titanium oxide added with aluminum as impurities and so forth. In particular, thin films of indium oxide containing 2 to 15 weight % of tin oxide (ITO) have superior transparency and conductivity, and therefore they are preferably used. Examples of the method of forming the transparent conductive layer include the vacuum deposition method, sputtering method, ion beam sputtering method and so forth.

The film thickness of the transparent conductive layer is preferably in the range of 15 to 300 nm. If the film thickness of the transparent conductive layer is 15 nm or larger, the film becomes a continuous film, and sufficient conductivity, transparency and flexibility can be obtained. On the other hand, if the film thickness is 300 nm or smaller, favorable transparency can be maintained, and favorable flex resistance can be obtained.

The transparent conductive layer may be provided either on the base material film side or the gas barrier coat layer (organic layer+inorganic layer) side so long as it is provided as an outermost layer. However, it is preferably provided on the gas barrier coat layer side in view of prevention of invasion of moisture contained in the base material film in a small amount.

### (Primer Layer)

In the film of the present invention, a known primer layer or inorganic thin film layer can be provided between the base material film and the gas barrier layer (inorganic layer and organic layer). Although acrylic resins, epoxy resins, urethane resins, silicone resins and so forth, for example, can be used for the primer layer, it is preferable in the present invention to use an organic/inorganic hybrid layer as the primer layer and an inorganic vapor-deposited layer or dense inorganic coating thin film prepared by a sol/gel method as the inorganic thin film layer. As the inorganic vapor-deposited layer, vapor-deposited layers of silica, zirconia, alumina and so forth are preferred. The inorganic vapor-deposited layer can be formed by the vacuum deposition method, sputtering method or the like.

### (Other Functional Layers)

On the gas barrier coat layer (organic layer+inorganic layer), or as an outermost layer, various known functional layers may be provided as required. Examples of the functional layers include optically functional layers such as anti-reflection layer, polarization layer, color filter, ultraviolet absorbing layer and light extraction efficiency improving layer, mechanically functional layers such as hard coat layer and stress relaxation layer, electrically functional layers such as antistatic layer and conductive layer, antifogging layer, antifouling layer, printable layer and so forth.

The film of the present invention suitably has an oxygen permeability of 0 to 0.1 mL/m²·day·atm, preferably 0 to 0.05 mL/m²·day·atm, more preferably 0 to 0.005 mL/m²·day·atm, at 38° C. and 0% and/or 90% of relative humidity. In particular, if a film having an oxygen permeability of 0.05 mL/m²·day·atm or less at 38° C. and 0% and/or 90% of relative humidity is used in LCD, degradation of the device by oxygen can be substantially avoided, and therefore such an oxygen permeability is preferred. Further, if a film having an oxygen permeability of 0.005 mL/m²·day·atm or less at 38° C. and 0% and/or 90% of relative humidity is used in an organic EL device, degradation of the device by oxygen can be substantially avoided, and therefore such an oxygen permeability is preferred.

Further, the film of the present invention suitably has a water vapor permeability of 0 to 0.1 g/m²·day, preferably 0 to 0.05 g/m²·day, more preferably 0 to 0.005 g/m²·day, at 38° C. and 90% of relative humidity. In particular, if a film having a water vapor permeability of 0.05 g/m²·day or less at 38° C. and 90% of relative humidity is used in LCD, degradation of the device by moisture can be substantially avoided, and therefore such a water vapor permeability is preferred. Further, if a film having a water vapor permeability of 0.005 g/m²·day or less at 38° C. and 90% of relative humidity is used in an organic EL device, degradation of the device by moisture can be substantially avoided, and therefore such a water vapor permeability is preferred.

It is preferred that the film of the present invention should maintain the oxygen permeability and water vapor permeability even after a bending treatment or heating treatment.

After a bending test, the film of the present invention suitably has an oxygen permeability of 0 to 0.1 mL/m²·day·atm, preferably 0 to 0.05 mL/m²·day·atm, more preferably 0 to 0.005 mL/m²·day·atm, at 38° C. and 0% and/or 90% of relative humidity. Further, after a bending test, the film of the present invention suitably has a water vapor permeability of 0 to 0.1 g/m²·day, preferably 0 to 0.05 g/m²·day, more preferably 0 to 0.005 g/m²·day, at 38° C. and 90% of relative humidity.

After a heat treatment, for example, a heat treatment at 250° C., the film of the present invention suitably has an oxygen permeability of 0 to 0.1 mL/m²·day·atm, preferably 0 to 0.05 mL/m²·day·atm, more preferably 0 to 0.005 mL/m²·day·atm, at 38° C. and 0% and/or 90% of relative humidity. Further, after the heat treatment, the film of the present invention suitably has a water vapor permeability of 0 to 0.1 g/m²·day, preferably 0 to 0.05 g/m²·day, more preferably 0 to 0.005 g/m²·day, at 38° C. and 90% of relative humidity.

After a heat treatment at 300° C., the film of the present invention suitably has an oxygen permeability of 0 to 0.1 mL/m²-day·atm, preferably 0 to 0.05 mL/m²·day·atm, more preferably 0 to 0.005 mL/m²·day·atm, at 38° C. and 0% and/or 90% of relative humidity. Further, after the heat treatment, the film of the present invention suitably has a water vapor permeability of 0 to 0.1 g/m²·day, preferably 0 to 0.05 g/m²·day, more preferably 0 to 0.005 g/m²·day, at 38° C. and 90% of relative humidity.

### [Organic-Inorganic Composite Composition]

The organic-inorganic composite composition of the present invention is characterized by comprising an inorganic compound and a resin having a glass transition temperature of 250° C. or higher. As the inorganic compound and resin having a glass transition temperature of 250° C. or higher contained in the organic-inorganic composite composition of the present invention, those described in the explanation of the gas barrier laminate film mentioned above can be used, and preferred embodiments thereof are also the same. The organic-inorganic composite composition of the present invention particularly preferably contains a metal oxide and a polymer having a spiro structure represented by the aforementioned formula (I) or a polymer having a cardo structure represented by the aforementioned formula (II).

The metal oxide used in the organic-inorganic composite composition of the present invention is not particularly limited, so long as a metal oxide derived from a metal that can form an oxide is chosen. However, metal oxides obtained by hydrolysis and polycondensation reactions based on a sol-gel method, such as those explained in the explanation of the gas barrier laminate film mentioned above, are preferably used. The metal atom constituting such metal oxides is preferably a metal atom selected from the group consisting of silicon, zirconium, aluminum, titanium and germanium. Further, the metal oxide contained in the organic-inorganic composite composition of the present invention may be a composite oxide derived from two or more kinds of metal atoms.

Preferred as the metal oxide contained in the organic-inorganic composite composition of the present invention are silicon oxide, aluminum oxide, zirconium oxide, titanium oxide, and germanium oxide, and more preferred are silicon oxide, aluminum oxide and zirconium oxide.

As for examples of preferred compounds of the polymer having a spiro structure represented by the formula (I) and the polymer having a cardo structure represented by the formula (II), the description in the explanation of the gas barrier laminate film mentioned above can be referred to.

In the organic-inorganic composite composition of the present invention, the ratio of weight contents of the metal oxide and the polymer having a spiro structure represented by the formula (I) or the polymer having a cardo structure represented by the formula (II) is preferably 5:95 to 70:30, more preferably 5:95 to 50:50, still more preferably 5:95 to 30:70.

The organic-inorganic composite composition of the present invention may contain a third ingredient depending on the type of the solvent or purpose, in addition to the inorganic compound such as metal oxides and the resin having a glass transition temperature of 250° C. or higher. Specifically, resin property modifiers such as plasticizers, dyes and pigments, antistatic agents, ultraviolet absorbers, antioxidants, inorganic microparticles, release accelerators, leveling agents, inorganic layered silicate compounds and lubricants may be added. The content of such a third ingredient is preferably 30 weight % or less, more preferably 20 weight % or less, still more preferably 10 weight % or less, particularly preferably 5 weight % or less.

### [Plastic Substrate]

The plastic substrate of the present invention is produced by using the aforementioned organic-inorganic composite composition. For the production, a method similar to the production method of the base material film described in the explanation of the gas barrier laminate film mentioned above may be employed, and a similar configuration can be adopted.

The plastic substrate of the present invention preferably has a metal oxide content of 5 to 70 weight %, more preferably 5 to 50 weight %, still more preferably 5 to 30 weight %. Further, the plastic substrate of the present invention preferably has a thickness of 40 to 200 μm, more preferably 50 to 150 μm, still more preferably 60 to 120 μm.

The thermal deformation temperature of the plastic substrate of the present invention is preferably increased by 2° C. or more, more preferably 5° C. or more, still more preferably 10° C. or more, because of inclusion of the metal oxide. The thermal deformation temperature referred to herein can be measured by the method described in the examples mentioned later. That is, the increase of the thermal deformation temperature can be obtained by measuring thermal deformation temperatures of a plastic substrate of the present invention and a plastic substrate having the same composition except that it does not contain any metal oxide at all and calculating the difference of them.

Further, the thermal expansion coefficient of the plastic substrate of the present invention is preferably decreased by 20 ppm/° C. or more, preferably 30 ppm/° C. or more, still more preferably 40 ppm/° C. or more, because of inclusion of the metal oxide. The thermal expansion coefficient referred to herein can be measured by the method described in the examples mentioned later. That is, decrease of the thermal expansion coefficient can be obtained by measuring thermal expansion coefficients of a plastic substrate of the present invention and a plastic substrate having the same composition except that it does not contain any metal oxide at all and calculating the difference of them.

The plastic substrate of the present invention has superior optical characteristics and mechanical characteristics. Specifically, a plastic substrate showing a small retardation and suitable for image forming devices is provided by the present invention. Moreover, the plastic substrate of the present invention is unlikely to deform due to heat and has superior durability. Therefore, the plastic substrate of the present invention does not deform, and conductivity of a transparent conductive film is not reduced during a heat treatment, formation of an oriented film, gas barrier film or the like performed after the film formation of the transparent conductive film. For these reasons, the plastic substrate of the present invention is preferably used for liquid crystal displays, organic EL devices, TFT arrays described below and so forth.

### [Image Display Device]

Although the use of the film and plastic substrate of the present invention is not particularly limited, it can be suitably used as a transparent electrode substrate of image display device because of the superior optical characteristics and mechanical characteristics thereof. The “image display device” referred to herein means a circularly polarizing plate, liquid crystal display device, touch panel, organic EL device or the like. Although explanation will be made for use of the film of the present invention for convenience of the explanation, the plastic film of the present invention can also be used in a similar manner.

### <Circularly Polarizing Plate>

A λ/4 plate and a polarizing plate can be laminated on a substrate obtained by forming a transparent conductive layer as a functional layer on the film of the present invention (referred to simply as “film substrate” hereinafter) to prepare a circularly polarizing plate. In this case, they are laminated so that the angle formed by the lagging axis of the λ/4 plate and the absorption axis of the polarizing plate should become 45°. As the polarizing plate, one stretched along a direction at an angle of 45° with respect to the machine direction (MD) is preferably used, and for example, the one described in Japanese Patent Laid-open Publication No. 2002-865554 can be suitably used.

### <Liquid Crystal Display Device>

A reflection type liquid crystal display device has a structure consisting of, in the order from the bottom, a lower substrate, reflective electrode, lower oriented film, liquid crystal layer, upper oriented film, transparent electrode, upper substrate, λ/4 plate and polarizing film. The film substrate of the present invention can be used as the aforementioned transparent electrode and upper substrate. In the case of a color display device, it is preferable to further provide a color filter layer between the reflective electrode and the lower oriented film or between the upper oriented film and the transparent electrode.

A transmission type liquid crystal display device has a structure consisting of, in the order from the bottom, a back light, polarizing plate, λ/4 plate, lower transparent electrode, lower oriented film, liquid crystal layer, upper oriented film, upper transparent electrode, upper substrate, λ/4 plate and polarization film. Among these, the film substrate of the present invention can be used as the aforementioned upper transparent electrode and upper substrate. In the case of a color display device, it is preferable to further provide a color filter layer between the lower transparent electrode and the lower oriented film or between the upper oriented film and the transparent electrode.

Although type of liquid crystal cell is not particularly limited, more preferred are the TN (Twisted Nematic) type, STN (Supper Twisted Nematic) type, HAN (Hybrid Aligned Nematic) type, VA (Vertically Alignment) type, ECB (Electrically Controlled Birefringence) type, OCB (Optically Compensatory Bend) type and CPA (Continuous Pinwheel Alignment) type.

### <Touch Panel>

As for touch panel, the film of the present invention can be applied to those described in Japanese Patent Laid-open Publication Nos. 5-127822, 2002-48913 and so forth.

### <Organic EL Device>

The film of the present invention can be used for organic EL devices as a substrate having a transparent electrode, after providing TFT if necessary. Specific examples of layer structure of organic EL display device include positive electrode/luminescent layer/transparent negative electrode, positive electrode/luminescent layer/electron transport layer/transparent negative electrode, positive electrode/hole transport layer/luminescent layer/electron transport layer/transparent negative electrode, positive electrode/hole transport layer/luminescent layer/transparent negative electrode, positive electrode/luminescent layer/electron transport layer/electron injection layer/transparent negative electrode, positive electrode/hole injection layer/hole transport layer/luminescent layer/electron transport layer/electron injection layer/transparent negative electrode and so forth.

When the film of the present invention is used in an organic EL device or the like, it is preferably used according to the disclosures of Japanese Patent Laid-open Publication Nos. 11-335661, 11-335368, 2001-192651, 2001-192652, 2001-192653, 2001-335776, 2001-247859, 2001-181616, 2001-181617, 2002-181816, 2002-181617 and 2002-056976 as well as those of Japanese Patent Laid-open Publication Nos. 2001-148291, 2001-221916 and 2001-231443.

That is, the film of the invention can be used as a base material film and/or protective film used for forming organic EL devices.

### EXAMPLES

Hereafter, the present invention will be further specifically explained by referring to examples. However, the materials, amounts used, ratios, types of processes, order of processes and so forth mentioned in the examples may be optionally changed so long as such changes do not depart from the spirit of the present invention. Therefore, the scope of the present invention should not be construed in any limitative way on the basis of the following examples.

### Example 1

### Preparation and Evaluation of Gas Barrier Laminate Films

### 1. Preparation of Base Material Films

Experiments were conducted by using PES (Tg=220° C.), C-3 (Tg=270° C.) and FL-7 (Tg=360° C.) as resins.

### <Film 1A: PES Alone>

Pellets of PES were dissolved in an N-methylpyrrolidone/dichloromethane mixed solvent (weight ratio: 1/1) to form a 15% solution, and the solution was applied and dried to obtain Film 1A having a thickness of 100 μm.

### <Film 1B: PES/Colloidal Silica=92/8>

Snowtex MEK-ST (produced by Nissan Chemical Industries, Ltd., dispersion of hydrophobic colloidal silica having a diameter of about 10 nm in MEK) was added to the solution used for Film 1A to form a uniform solution, and the solution was applied and dried to obtain Film 1B having a thickness of 100 μm. Snowtex MEK-ST was added so that the weight ratio of the resin and the inorganic ingredient should become 92/8 after drying.

### <Film 1C: PES/Colloidal Silica=84/16>

Film 1C having a thickness of 100 μm was obtained in the same manner as that used for Film 1B except that the film was prepared so as to have a resin/inorganic ingredient weight ratio of 84/16 after drying.

### <Film 1D: PES/Colloidal Silica=76/24>

Film 1D having a thickness of 100 μm was obtained in the same manner as that used for Film 1B except that the film was prepared so as to have a resin/inorganic ingredient weight ratio of 76/24 after drying.

### <Film 1E: PES/Diniobium Pentoxide=92/8>

A dispersion of niobium pentoxide (Nb₂O₅) having a negative thermal expansion coefficient and a diameter of about 20 nm was prepared by reacting niobium (V) ethoxide and water in 2-methoxyethanol. This dispersion and the solution used for Film 1A were mixed to form a uniform solution, and the solution was applied and dried to obtain Film 1E having a thickness of 100 μm. The diniobium pentoxide was added so that the film should have a resin/inorganic ingredient weight ratio of 92/8 after drying.

### <Film 1F: PES/Diniobium Pentoxide=84/16>

Film 1F having a thickness of 100 μm was obtained in the same manner as that used for Film 1E except that the film was prepared so as to have a resin/inorganic ingredient weight ratio of 84/16 after drying.

### <Film 1G: PES/Diniobium Pentoxide=76/24>

Film 1G having a thickness of 100 μm was obtained in the same manner as that used for Film 1E except that the film was prepared so as to have a resin/inorganic ingredient weight ratio of 76/24 after drying.

### <Film 1H: C-3 Alone>

Powder of C-3 was dissolved in dichloromethane to form a 15% solution, and the solution was applied and dried to obtain Film 1H having a thickness of 100 μm.

### <Film 1I: C-3/Colloidal Silica=92/8>

Film 1I having a thickness of 100 μm was obtained in the same manner as that used for Film 1B except that PES was changed to the resin C-3.

### <Film 1J: C-3/Colloidal Silica=84/16>

Film 1J having a thickness of 100 μm was obtained in the same manner as that used for Film 1C except that PES was changed to the resin C-3.

### <Film 1K: C-3/Colloidal Silica=76/24>

Film 1K having a thickness of 100 μm was obtained in the same manner as that used for Film 1D except that PES was changed to the C-3.

### <Film 1L: C-3/Diniobium Pentoxide=92/8>

Film 1L having a thickness of 100 μm was obtained in the same manner as that used for Film 1E except that PES was changed to the resin C-3.

### <Film IM: C-3/Diniobium Pnetoxide=84/16>

Film 1M having a thickness of 100 μm was obtained in the same manner as that used for Film 1F except that PES was changed to the resin C-3.

### <Film 1N: C-3/Diniobium Pnetoxide=76/24>

Film 1N having a thickness of 100 μm was obtained in the same manner as that used for Film 1G except that PES was changed to the resin C-3.

### <Film 10: FL-7 Alone>

Powder of FL-7 was dissolved in a dichloromethane/anisole mixed solvent (weight ratio: 9/1) to form a 15% solution, and the solution was applied and dried to obtain Film 10 having a thickness of 100 μm.

### <Film 1P: FL-7/Colloidal Silica=92/8>

Film 1P having a thickness of 100 μm was obtained in the same manner as that used for Film 1B except that PES was changed to the resin FL-7.

### <Film 1Q: FL-7/Colloidal Silica=84/16>

Film 1Q having a thickness of 100 μm was obtained in the same manner as that used for Film 1C except that PES was changed to the resin FL-7.

### <Film 1R: FL-7/Colloidal Silica=76/24>

Film 1R having a thickness of 100 μm was obtained in the same manner as that used for Film 1D except that PES was changed to the resin FL-7.

### <Film 1S: FL-7/Diniobium Pnetoxide=92/8>

Film 1S having a thickness of 100 μm was obtained in the same manner as that used for Film 1E except that PES was changed to the resin FL-7.

### <Film 1T: FL-7/Diniobium Pnetoxide=84/16>

Film 1T having a thickness of 100 μm was obtained in the same manner as that used for Film 1F except that PES was changed to the resin FL-7.

### <Film 1U: FL-7/Diniobium Pnetoxide=76/24>

Film 1U having a thickness of 100 μm was obtained in the same manner as that used for Film 1G except that PES was changed to the resin FL-7.

### 2. Preparation of Samples 2A to 2U

### (1) Film Formation of Inorganic Layer

A commercially available roll-to-roll type sputtering apparatus was used. This apparatus had a vacuum chamber, and a drum for heating or cooling a base material film by contact on the surface was disposed at the center of the chamber. Further, a rolling-up roller for winding the base material film was disposed in the vacuum chamber. The base material film wound around the roller was wound around the drum via a guide roller, and further the base material film was wound around a winding roller via another guide roller. As for a vacuum pumping system, the gas in the vacuum chamber was always evacuated by vacuum pumps from exhaust ports. As for a film formation system, a target was placed on a cathode connected to an electric discharge power source of the direct current type, which could apply pulse electric power. This electric discharge power source was connected to a controller, and this controller was further connected to a piezo-electric valve unit, which supplied reactive gas to the vacuum chamber through a piping while controlling the introduced gas volume. Further, the vacuum chamber was designed so that an electric discharge gas could be supplied to the chamber at a constant flow rate. A reactive gas introduction rate providing the desired film quality was determined, and the discharge was maintained in the transition region. The voltage value at this point was considered a preset value, and a command is transmitted from the controller to the piezo-electric valve unit so that, when the voltage was higher than the preset value, the reactive gas flow rate should be decreased, and when the voltage was lower than the preset value, the reactive gas flow rate should be increased. In this way, the flow rate of the reactive gas supplied to the vacuum chamber was controlled to be an appropriate value. Hereafter, specific conditions will be explained.

As the base material film, Films 1A to 1U were used. Si was set as a target, and a DC power source of the pulse applying type was prepared as the electric discharge power source. The vacuum pump was started to evacuate the inside of the vacuum chamber to about 10⁻⁴ Pa, and argon as the electric discharge gas and oxygen as the reactive gas were introduced. When the atmospheric pressure was stabilized, the electric discharge power source was turned on to generate plasma over the Si target at an electric discharge power of 5 kW, and after the film formation pressure was lowered to 0.030 Pa, the sputtering process was started. The voltage value at this point was 610 V. This voltage was considered a preset value, and the discharge voltage was controlled to be maintained constant by transmitting a command from the controller to the piezo-electric valve unit so that when the discharge voltage was lower than the preset value in the transition region, the oxygen flow rate should be increased, and when the discharge voltage was higher than the preset value in the transition region, the oxygen flow rate should be decreased. As described above, an SiOₓ layer having a thickness of 50 nm was formed on each of the base material films. The obtained films were designated Base material film samples 2A to 2U.

### (2) Film Formation of Organic Layer

In an amount of 12.37 g of 3-ethyl-3-[3-(triethoxysilyl)propyloxymethyl]oxetane synthesized according to the method described in Japanese Patent Laid-open Publication No. 2000-264969, 1.05 g of 10% aqueous solution of tetramethylammonium hydroxide, 1.14 g of water and 300 mL 1,4-dioxane were charged and refluxed by heating with stirring for 16 hours. Then, 200 mL of the solvent was evaporated under reduced pressure to concentrate the reaction system, and the reaction was continued for 6 hours. Thereafter, the solvent and others were evaporated under reduced pressure, 200 mL of toluene was added as substitutive solvent, and the mixture was washed with water and dehydrated to obtain an objective product. It was confirmed by GPC and NMR that a silsesquioxane compound containing an oxetanyl group and having an average molecular weight (Mn) of about 2000 was obtained. A coating composition prepared by mixing 100 parts (part by weight, the same shall apply hereafter) of the above compound and 2 parts of diphenyl-4-thiophenoxysulfonium hexafluoroantimonate as a polymerization initiator was applied on each of the base material films (2A to 2U) so that the coated thickness should become about 0.4 μm by bar coating and irradiated with an ultraviolet ray in the atmosphere at an irradiation intensity of 70 mJ/cm² by using an ultraviolet irradiation apparatus utilizing a high pressure mercury lamp of 395 W (TOSCURE 401, Harrison Toshiba Lighting). There were prepared samples (3A to 3U) on which the coated composition was cured by ultraviolet irradiation at such a dose that the composition should sufficiently react (2000 mJ/cm², confirmed by FT-IR).

### (3) Film Formation of Second Inorganic Layer

Samples provided with an inorganic layer (4A to 4U) were prepared in the same manner as that described in (1) except that samples obtained by adhering Samples 3A to 3U to a guide base as the base material film were used.

### (4) Preparation of Transparent Electrode Layer

Each of the base material films 4A to 4U was introduced into a vacuum chamber, and a transparent electrode composed of an IXO thin film having a thickness of 0.2 μm was formed by DC magnetron sputtering using an IXO target to prepare samples (5A to 5U) on which the transparent electrode was formed.

### 3. Flex Resistance Test

The base material films 5A to 5U were cut into a size of 20 cm×30 cm, both ends of each were adhered to form a cylinder with the barrier coat layer as the outer surface, and then the films were transported 5 times by rotation at a rate of 30 cm/minutes between two of transportation rollers having a diameter of 12 mm between which a tension of about 1 N was applied, while paying attentions so that the films should fully contact with the rollers and the films should not slip on the rollers. The samples were conditioned for moisture content in an environment of 25° C. and 60% RH for 8 hours before use, and the test was performed in a laboratory of the same conditions.

### 4. Heating Test at 250° C.

The gas barrier layer surface of each of the base material films 5A to 5U was heated by area irradiation with a commercially available infrared heater until the surface temperature reached 250° C. and then left to cool to 25° C. for obtain samples. The surface temperature was monitored by using a commercially available radiation pyrometer.

### 5. Heating Test at 300° C.

The gas barrier layer surface of each of the base material films 5A to 5U was heated by area irradiation with a commercially available infrared heater until the surface temperature reached 300° C. and then left to cool to 25° C. for obtain samples. The surface temperature was monitored by using a commercially available radiation pyrometer.

### 6. Gas Permeability

Oxygen permeability at 38° C. and 0% of relative humidity and water vapor permeability at 38° C. and 90% of relative humidity were measured by the MOCON method for untreated samples, samples after the flex resistance test, samples after the 250° C. heating test and samples after the 300° C. heating test of the base material films 5A to 5U. The results are shown in Table 1.

TABLE 1

| | | | | | | After flex | | After 250° C. | | After 300° C. | | |
|---|---|---|---|---|---|---|---|---|---|---|---|---|
| | | | | Untreated | | resistance test | | heating test | | heating test | | |
| | Base material film | | | | Water | | Water | | Water | | Water | |
| | | Inorganic | Addition | Oxygen | vapor | Oxygen | vapor | Oxygen | vapor | Oxygen | vapor | |
| | Polymer | compound | ratio | perme- | perme- | perme- | perme- | perme- | perme- | perme- | perme- | |
| Sample | \textcircled{1} | \textcircled{2} | (\textcircled{1}/\textcircled{2}) | ability | ability | ability | ability | ability | ability | ability | ability | Note |
| 5A | PES | — | — | <0.005 | <0.005 | <0.005 | <0.005 | 723 | 53 | 897 | 72 | Comparative |
| 5B | PES | Colloidal | 92/8 | <0.005 | <0.005 | <0.005 | <0.005 | 653 | 44 | 772 | 65 | Comparative |
| | | silica | | | | | | | | | | |
| 5C | PES | Colloidal | 84/16 | <0.005 | <0.005 | <0.005 | <0.005 | 543 | 34 | 693 | 51 | Comparative |
| | | silica | | | | | | | | | | |
| 5D | PES | Colloidal | 76/24 | <0.005 | <0.005 | 9 | 0.4 | 436 | 23 | 597 | 33 | Comparative |
| | | silica | | | | | | | | | | |
| 5E | PES | Nb₂O₅ | 92/8 | <0.005 | <0.005 | <0.005 | <0.005 | 382 | 12 | 583 | 23 | Comparative |
| 5F | PES | Nb₂O₅ | 84/16 | <0.005 | <0.005 | <0.005 | <0.005 | 196 | 8 | 476 | 9 | Comparative |
| 5G | PES | Nb₂O₅ | 76/24 | <0.005 | <0.005 | 11 | 0.2 | 94 | 6 | 227 | 14 | Comparative |
| 5H | C-3 | — | — | <0.005 | <0.005 | <0.005 | <0.005 | 12 | 2 | 103 | 8 | Comparative |
| 5I | C-3 | Colloidal | 92/8 | <0.005 | <0.005 | <0.005 | <0.005 | 0.2 | 0.2 | 85 | 1.1 | Invention |
| | | silica | | | | | | | | | | |
| 5J | C-3 | Colloidal | 84/16 | <0.005 | <0.005 | <0.005 | <0.005 | <0.005 | <0.005 | 31 | 0.8 | Invention |
| | | silica | | | | | | | | | | |
| 5K | C-3 | Colloidal | 76/24 | <0.005 | <0.005 | 4 | 0.3 | <0.005 | <0.005 | 12 | 0.2 | Invention |
| | | silica | | | | | | | | | | |
| 5L | C-3 | Nb₂O₅ | 92/8 | <0.005 | <0.005 | <0.005 | <0.005 | <0.005 | <0.005 | 5 | 0.2 | Invention |
| 5M | C-3 | Nb₂O₅ | 84/16 | <0.005 | <0.005 | <0.005 | <0.005 | <0.005 | <0.005 | 0.1 | 0.1 | Invention |
| 5N | C-3 | Nb₂O₅ | 76/24 | <0.005 | <0.005 | 8 | 0.2 | <0.005 | <0.005 | 0.07 | 0.03 | Invention |
| 5O | FL-7 | — | — | <0.005 | <0.005 | <0.005 | <0.005 | 5 | 1 | 15 | 1.3 | Comparative |
| 5P | FL-7 | Colloidal | 92/8 | <0.005 | <0.005 | <0.005 | <0.005 | 0.1 | 0.1 | 0.1 | 0.1 | Invention |
| | | silica | | | | | | | | | | |
| 5Q | FL-7 | Colloidal | 84/16 | <0.005 | <0.005 | <0.005 | <0.005 | <0.005 | <0.005 | <0.005 | <0.005 | Invention |
| | | silica | | | | | | | | | | |
| 5R | FL-7 | Colloidal | 76/24 | <0.005 | <0.005 | 3 | 0.2 | <0.005 | <0.005 | <0.005 | <0.005 | Invention |
| | | silica | | | | | | | | | | |
| 5S | FL-7 | Nb₂O₅ | 92/8 | <0.005 | <0.005 | <0.005 | <0.005 | <0.005 | <0.005 | <0.005 | <0.005 | Invention |
| 5T | FL-7 | Nb₂O₅ | 84/16 | <0.005 | <0.005 | <0.005 | <0.005 | <0.005 | <0.005 | <0.005 | <0.005 | Invention |
| 5U | FL-7 | Nb₂O₅ | 76/24 | <0.005 | <0.005 | 7 | 0.2 | <0.005 | <0.005 | <0.005 | <0.005 | Invention |

Unit of oxygen permeability: cc/m² · day · atm, Unit of water vapor permeability: g/m² · day

It can be seen that all of the untreated samples used in this example had superior gas barrier property represented by oxygen permeability and water vapor permeability lower than the detection limits.

The results of the flex resistance test indicate that an inorganic substance content lower than 20 weight % in the base material film is desirable in order to maintain the gas barrier property even after the flex resistance test, and the gas barrier property of the samples having an inorganic substance content higher than 20 weight % (5D, 5G, 5K, 5N, 5R and 5U) was degraded after the flex resistance test. This indicates that a small addition amount of inorganic substance is important for imparting flexibility to the substrate.

Further, the results of the 250° C. heating test indicate that the gas barrier property of the samples using PES having Tg of 220° C. was markedly degraded after the 250° C. heating test for the both cases that the base material film consisted of the resin alone (5A) and the base material film contained an inorganic compound (5B to 5G). When C-3 having Tg of 270° C. and FL-7 having Tg of 360° C. were used, whereas degradation of the gas barrier property was observed for the samples utilizing a base material film consisting of a resin alone (5H, 50) after the 250° C. heating test, degradation of the gas barrier property was not observed for the samples utilizing a base material film containing inorganic compound at a content higher than 10 weight % (5J, 5K, 5M, 5N, 5Q, 5R, 5T and 5U) even after the 250° C. heating test. Further, whereas degradation of the gas barrier property was observed for the samples containing an inorganic compound having a positive thermal expansion coefficient at a content lower than 10 weight % (5I, 5P) after the 250° C. heating test, degradation of the gas barrier property was not observed for the samples containing an inorganic compound having a negative line thermal expansion coefficient at a content less than 10 weight % (5L, 5S) even after the 250° C. heating test. These results indicate that, for the samples containing an inorganic compound having a negative thermal expansion coefficient, degradation of the gas barrier property by heating can be suppressed by addition of a small amount of the inorganic compound.

Furthermore, the results of the 300° C. heating test indicate that the gas barrier property of both of the samples utilizing PES having Tg of 220° C. (5A to 5G) and the samples utilizing C-3 having Tg of 270° C. (5H to 5N) was markedly degraded after the 300° C. heating test. On the other hand, when FL-7 having Tg of 360° C. was used, whereas degradation of the gas barrier property was observed for the sample utilizing a base material film consisting of a resin alone (50) after the 300° C. heating test, degradation of the gas barrier property was not observed for the sample utilizing a base material film containing an inorganic compound at a content higher than 10 weight % (5Q, 5R, 5T and 5U) even after the 300° C. heating test. Further, for the samples containing an inorganic compound having a positive thermal expansion coefficient, degradation of the gas barrier property was observed with an inorganic compound content lower than 10 weight % (5P) after the 300° C. heating test. On the other hand, for the samples containing an inorganic compound having a negative thermal expansion coefficient, degradation of the gas barrier property was not observed with an inorganic compound content lower than 10 weight % (5S) even after the 300° C. heating test. These results indicate that, for the samples containing an inorganic compound having a negative thermal expansion coefficient, degradation of the gas barrier property by heating can be suppressed by addition of a small amount of the inorganic compound.

These results indicate that a smaller addition amount of the inorganic substance is more advantageous for imparting flexibility to the substrate, and a larger addition amount of the inorganic substance is more advantageous for maintaining the gas barrier property after the heat treatment. An inorganic compound having a negative thermal expansion coefficient can maintain the gas barrier property with a smaller addition amount even after the heat treatment compared with an inorganic compound having a positive thermal expansion coefficient, and therefore an inorganic compound having a negative thermal expansion coefficient is more preferred in view of coexistence of gas barrier property and flexibility. Moreover, in order to maintain the gas barrier property even after the heat treatment, it is effective to use a resin having Tg higher than the heating temperature.

### Example 2

### Preparation and Evaluation of Organic EL Devices Using Gas Barrier Laminate Film

### 1. Preparation of Organic EL Devices

From the transparent electrode (IXO) in each of the base material film 5P to 5U, an aluminum lead wire was connected to form a laminated structure. An aqueous dispersion of polyethylene dioxythiophene/polystyrenesulfonic acid (Baytron P produced by BAYER, solid content: 1.3 weight %) was applied on the surface of the transparent electrode by spin coating and then vacuum-dried at 150° C. for 2 hours to form a hole transporting organic thin film layer having a thickness of 100 nm. These were designated Substrate 6P to 6U.

Further, a coating solution for light-emitting organic thin film layer having the following composition was applied on one side of a temporary support made of polyethersulfone having a thickness of 188 μm (SUMILITE FS-1300 produced by Sumitomo Bakelite) by using a spin coater and dried at room temperature to form a light-emitting organic thin film layer having a thickness of 13 nm on the temporary support. This was designated Transfer Material Y.

| | | |
|---|---|---|
| Polyvinyl carbazole | 40 | parts by weight |
| (Mw = 63000, Aldrich) | | |
| Tris(2-phenylpyridine) iridium | 1 | part by weight |
| complex (Ortho-metalated complex) | | |
| Dichloroethane | 3200 | parts by weight |

The light-emitting organic thin film layer side of Transfer Material Y was overlaid on the upper surface of the organic thin film layer in each of Substrates 6P to 6U, heated and pressurized under the conditions of 160° C., 0.3 MPa and 0.05 m/min by using a pair of heat rollers, and then the temporary support was delaminated to form a light-emitting organic thin film layer on the upper surface in each of Substrates 6P to 6U. These were designated Substrate 8P to 8U.

Further, a patterned mask for vapor deposition (mask providing a light-emitting area of 5 mm×5 mm) was set on one side of a polyimide film (UPILEX-50S produced by Ube Industries) cut into a 25-mm square and having a thickness of 50 μm, and Al was vapor-deposited in a reduced pressure atmosphere of about 0.1 mPa to form an electrode having a film thickness of 0.3 μm. LiF was vapor-deposited by DC magnetron sputtering using a LiF target with a film thickness of 3 nm in the same pattern as the Al layer. An aluminum lead wire was connected to the Al electrode to form a laminated structure. A coating solution for electron transporting organic thin film layer having the following composition was applied on the obtained laminated structure by using a spin coater and vacuum-dried at 80° C. for 2 hours to form an electron transporting organic thin film layer having a thickness of 15 nm on LiF. This was designated Substrate Z.

| | |
|---|---|
| Polyvinyl butyral | 10 parts by |
| (2000L produced by Denki | weight |
| Kagaku Kogyo, Mw = 2000,) | |
| Electron transporting compound | 20 parts by |
| having the followinf structure | weight |
| 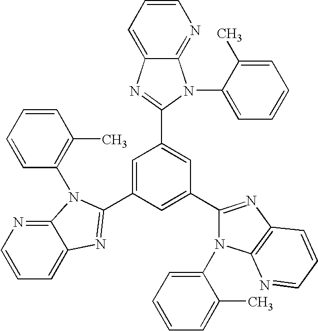 | |
| 1-Butanol | 3500 parts by |
| | weight |

Each of Substrates 8P to 8U and Substrate Z were stacked so that the electrodes should face each other via the light-emitting organic thin film layer between them, heated and pressurized at 160° C., 0.3 MPa and 0.05 m/min by using a pair of heat rollers to obtain Organic EL Devices 9P to 9U.

### 2. Evaluation of Organic EL Devices

DC voltage was applied to the obtained Organic EL Devices 9P to 9U by using Source-Measure Unit Model 2400 (Toyo Corporation) to allow them to emit light. All of the devices favorably emitted light. After the production of the devices, they were left in an environment of 25° C. and 75% RH for 1 month. Then, they were allowed to emit light in the same manner. As a result, all of the devices favorably emitted light.

Each of separately prepared organic devices of the same types was wound around a roller having a diameter of 12 mm so that the light-emitting surface should face inward, and then the device was unrolled into a flat shape. This procedure was repeated 5 times, and then the devices were left at 40° C. and 90% of relative humidity for 10 days and thereafter allowed to emit light in the same manner. As a result, Organic EL devices 9P, 9Q, 9S and 9T favorably emitted light. On the other hand, the ratios of the non-light emitting areas of organic EL devices 9R and 9U exceeded 80%, and these devices were evidently degraded. It is presumed that the base material films having superior flexibility contributed to prevention of slight degradation of the laminate barrier layer, and therefore the different base material films provided different results.

### Example 3

### Preparation and Evaluation of Plastic Substrates

### 1. Preparation of Resin (I-7)

A polyester resin (I-7) was obtained by the method described below.

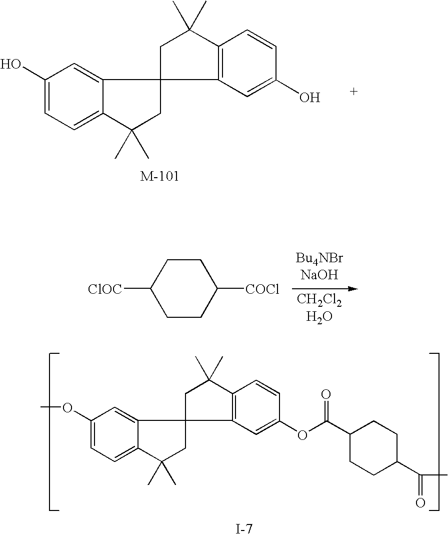

A solution obtained by dissolving 0.06 g of sodium hydrosulfite and 0.56 g of tetrabutylammonium bromide in 75 mL of water was added to a suspension obtained by suspending 6.16 g of M-101 in 40 mL of methylene chloride and vigorously stirred. To the mixture, 21 mL of 2 mol/L aqueous solution of NaOH and a solution of 4.18 g of cyclohexanedicarboxilic acid dichloride in 20 mL of methylene chloride were simultaneously added at room temperature over 1 hour. After the addition, the reaction was allowed for further 6 hours, and then the organic layer was separated by phase separation. Further, the organic layer was washed twice with 300 mL of diluted hydrochloric acid, and methylene chloride was evaporated under reduced pressure. Methylene chloride was added to the residue for dissolution, and after removal of dusts by filtration, the mixture was slowly poured into 200 mL of methanol. The precipitated resin was collected by filtration, washed with methanol and dried to obtain 7.42 g of a resin (I-7) as white solid. The obtained resin (I-7) had a number average molecular weight of 42,000 and Tg of 221° C.

The monomer (M-101) having a spirobiindane structure used above can be produced by a known method. That is, it can be prepared by, for example, the methods described in U.S. Pat. No. 3,544,638, Japanese Patent Laid-open Publication No. 62-10030 and so forth.

### 2. Preparation of Resin (C-1)

A polycarbonate resin (C-1) was obtained by the method described below.

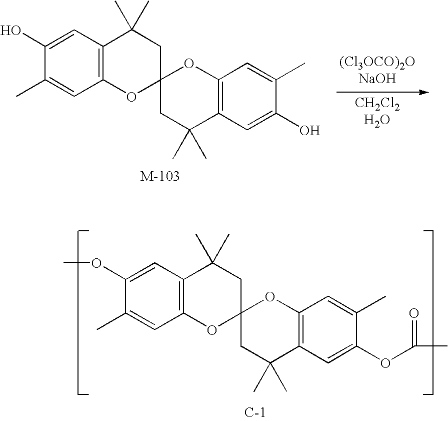

A solution obtained by dissolving 0.2 g sodium hydrosulfite and 17.8 g of sodium hydroxide in 200 mL of water was added to a solution obtained by dissolving 20.48 g of M-103 and 52.7 mg of t-butylphenol in 225 mL of methylene chloride and vigorously stirred. To the mixture, a solution of 6.92 g of triphosgene in 25 mL of methylene chloride was added over 30 minutes. After the addition, the reaction was allowed for further 1 hour, and then 0.2 mL of triethylamine was added to the reaction mixture. After the reaction was allowed further 4 hours, the organic layer was separated by phase separation. Further, the organic layer was washed twice with 300 mL of diluted hydrochloric acid, and methylene chloride was evaporated under reduced pressure. In a volume of 80 mL of methylene chloride was added to the residue for dissolution, and after removal of dusts by filtration, the solution was slowly poured into 400 mL of methanol. The precipitated resin was collected by filtration, washed with methanol and dried to obtain 15.7 g of a resin (C-1) as white solid. The obtained resin (C-1) had a number average molecular weight of 86,000 and Tg of 214° C.

The monomer (M-103) having a spirobichroman structure used above can be prepared by a known method. That is, it can be prepared by, for example, the methods described in Journal of Chemical Society, vol. 111, p. 4953 (1989), Japanese Patent Laid-open Publication No. 62-130735 and so forth.

### 3. Preparation of Plastic Substrates

Tetrahydrofuran was added to 4.0 g of the resin (I-7) prepared above to form a solution having a concentration of 10 weight %. This solution was filtered through a 5-μm filter, then added with 1.0 g of phenyltrimethoxysilane and 0.1 g of 0.1 mol/L hydrochloric acid and stirred at 25° C. for 2 hours. Then, the obtained solution was cast on a glass substrate by using a doctor blade. After the casting, the solution was dried by heating at 80° C. for 2 hours and at 120° C. for 8 hours, and then the film was delaminated from the glass substrate to prepare a plastic substrate F-101. Further, plastic substrates F-102 to F-104 were prepared in the same manner except that the ratio etc. of the resin and metal oxide precursor were changed as shown in Table 2 mentioned below. The data for the plastic substrate F-101 are also shown in Table 2.

In a similar manner, plastic substrates F-105 to F-110 were prepared by using the resin (C-1), resin (C-2), resin (1-14) and a commercially available polycarbonate (Panlite L1225Z produced by Teijin Chemicals Ltd.). When Panlite was used, the substrates were prepared by using a solvent obtained by mixing tetrahydrofuran and N,N-dimethylformamide at a volume ratio of 1/4 instead of tetrahydrofuran.

TABLE 2

| | | | | | Amount of | |
|---|---|---|---|---|---|---|
| | | Amount | Amount | Amount | hydro- | |
| | | of | of | of | chloric | |
| | | resin | PhTMOS | TEOS | acid | |
| Film | Resin | (g) | (g) | (g) | (g) | Note |
| F-101 | I-7 | 4.0 | 1.0 | 0.0 | 0.1 | Invention |
| F-102 | I-7 | 3.5 | 1.5 | 0.0 | 0.1 | Invention |
| F-103 | I-7 | 2.5 | 2.5 | 0.0 | 0.1 | Invention |
| F-104 | I-7 | 3.5 | 1.0 | 1.0 | 0.25 | Invention |
| F-105 | C-1 | 4.0 | 1.0 | 0.0 | 0.1 | Invention |
| F-106 | C-2 | 4.0 | 1.0 | 0.0 | 0.1 | Invention |
| F-107 | I-14 | 4.0 | 1.0 | 0.0 | 0.1 | Invention |
| F-108 | I-14 | 4.0 | 1.0 | 1.0 | 0.25 | Invention |
| F-109 | Panlite | 4.0 | 1.0 | 0.0 | 0.1 | Comparative |
| F-110 | Panlite | 3.5 | 1.0 | 1.0 | 0.25 | Comparative |

PhTMOS = Phenyltrimethoxysilane TEOS = Tetraethoxysilane Hydrochloric acid = 0.1 mol/l

### 4. Evaluation of Physical Properties of Plastic Substrates

Thickness, appearance and in-plane retardation values of the plastic substrates F-101 to F-110 are shown in Table 3. Further, TMA measurement and Tensilon measurement of the obtained films were performed by the methods described below. For comparison, plastic substrates F-111 to F-113 utilizing the resin (I-7), resin (C-1) and resin (I-14) were produced without adding a metal oxide, and the results obtained for them are also shown in Table 3.

### <Mechanical Characteristics of Films>

A film sample (1.0 cm×5.0 cm) was prepared, and tensile fracture ductility of the sample were measured under a condition of a drawing speed of 3 mm/minute by using Tensilon RTM-25 produced by Toyo Baldwin Co., Ltd. The measurement was performed for 3 samples for each type, and an average of the measured values was calculated (the samples were left overnight at 25° C. and 60% RH before use, chuck gap: 3 cm).

### <Coefficient of Linear Thermal Expansion (CTE) of Films>

A film sample (0.5 cm×2.0 cm) was prepared, and linear thermal expansion coefficient of the sample was measured under a condition of a tensile load of 100 mN by the tensile loading method using TMA (TMA 8310 produced by Rigaku International).

TABLE 3

| | | | | | Thermal | Thermal | Tensile | |
|---|---|---|---|---|---|---|---|---|
| | | | | | deformation | expansion | fracture | |
| | | Thickness | | RE | temperature | coefficient | ductility | |
| Film | Resin | (μm) | Appearance | (nm) | (° C.) | (ppm/° C.) | (%) | Note |
| F-101 | I-7 | 101 | Transparent | 3 | 207 | 52 | 10.8 | Invention |
| F-102 | I-7 | 99 | Transparent | 2 | 208 | 48 | 10.2 | Invention |
| F-103 | I-7 | 100 | Transparent | 2 | 208 | 47 | 9.8 | Invention |
| F-104 | I-7 | 100 | Transparent | 3 | 212 | 42 | 9.6 | Invention |
| F-105 | C-1 | 98 | Transparent | 8 | 214 | 50 | 8.7 | Invention |
| F-106 | C-2 | 102 | Transparent | 4 | 276 | 48 | 7.4 | Invention |
| F-107 | I-14 | 100 | Transparent | 8 | 302 | 45 | 21.2 | Invention |
| F-108 | I-14 | 101 | Transparent | 9 | 306 | 41 | 18.6 | Invention |
| F-109 | Panlite | 102 | Transparent | 32 | 145 | 52 | 5.8 | Invention |
| F-110 | Panlite | 98 | Transparent | 30 | 148 | 47 | 4.5 | Comparative |
| F-111 | I-7 | 98 | Transparent | 3 | 204 | 80 | 12.5 | Comparative |
| F-112 | C-1 | 102 | Transparent | 10 | 210 | 82 | 9.6 | Comparative |
| F-113 | I-14 | 100 | Transparent | 9 | 295 | 68 | 24.1 | Comparative |

Re = Retardation

From the results shown in Table 3, it can be seen that the films prepared with the resins of the present invention had a small retardation value and thus had superior optical characteristics. It can also be seen that thermal deformation temperature of the plastic substrates obtained from the organic-inorganic composite compositions of the present invention was improved, and low thermal expansion was attained in them. Moreover, all of the plastic substrates of the present invention had good transparency represented by a haze less than 1% and total optical transmission of 88% or higher.

### Example 4

### Preparation and Evaluation of Image Display Devices

### 1. Preparation of Substrates for Display Devices

### <Gas Barrier Layer>

Gas barrier layers were sputtered on the both surfaces of each of the film substrates shown in Table 4 by the DC magnetron sputtering method at an output of 5 kW under vacuum of 500 Pa in an Ar atmosphere using SiO₂ as a target. The obtained gas barrier layers had a film thickness of 60 nm.

### <Transparent Conductive Layer>

A transparent conductive layer consisting of an ITO film having a thickness of 140 nm was provided on one side of the obtained film substrate heated to 100° C. by the DC magnetron sputtering method at an output of 5 kW under vacuum of 0.665 Pa in an Ar atmosphere using ITO (In₂O₃: 95 weight %, SnO₂: 5 weight %) as a target.

### <Protective Layer>

The constituents mentioned below were mixed and dissolved at an ordinary temperature to prepare a coating solution, and the coating solution was coated on the barrier layer with a bar coater so as to have a thickness of 3 μm (after drying), heated at 80° C. for 10 minutes and irradiated with an ultraviolet ray.

| | | |
|---|---|---|
| Acrylic resin (acrylic resin | 100 | weight parts |
| having Tg of 105° C., molecular | | |
| weight of 67000 and acid value | | |
| of 2, LR-1065 produced by | | |
| Mitsubishi Rayon Co., Ltd.) | | |
| Silane coupling agent (N-phenyl- | 1 | weight part |
| γ-aminopropyltrimethoxysilane, | | |
| KBM-573 produced by Shin-Etsu | | |
| Chemical Co., Ltd.) | | |
| Butyl acetate | 400 | weight parts |

### 2. Evaluation of Substrates for Image Display Devices

Surface resistance of the substrates for image display devices prepared as described above (plastic substrate having a transparent conductive layer) was measured by the method according to JIS-C-2141. Further, surface resistance was also measured after the aforementioned heat treatment at 250° C., and appearance after the heat treatment was also observed. Furthermore, refractive indexes at a wavelength of 632.8 nm along the film plane directions were measured by using an automatic birefringence meter (KOBRA-21ADH produced by Oji Scientific Instruments Co., Ltd.), and retardation was calculated from the values in accordance with the following equation.

Retardation (Re)=|nMD−nTD|×d

In the equation, nMD is a refractive index of a film for transverse direction, nTD is a refractive index of the film for longitudinal direction, and d is thickness of the film.

TABLE 4

| | | Initial | Resistance | | |
|---|---|---|---|---|---|
| | | resistance | after heating | Appearance | |
| Film | Resin | (Ω/□) | (Ω/□) | after heating | Note |
| F-101 | I-7 | 32 | 33 | Good | Invention |
| F-102 | I-7 | 33 | 33 | Good | Invention |
| F-103 | I-7 | 32 | 33 | Good | Invention |
| F-104 | I-7 | 32 | 32 | Good | Invention |
| F-105 | C-1 | 32 | 33 | Good | Invention |
| F-106 | C-1 | 32 | 33 | Good | Invention |
| F-107 | I-14 | 31 | 32 | Good | Invention |
| F-108 | I-14 | 31 | 31 | Good | Invention |
| F-109 | Panlite | 32 | 33 | Slight cracks | Comparative |
| F-110 | Panlite | 32 | 33 | Slight cracks | Comparative |
| F-111 | I-7 | 32 | 110 | Slight cracks | Comparative |
| F-112 | C-1 | 32 | 124 | Significant | Comparative |
| | | | | cracks | |
| F-113 | I-14 | 31 | 220 | Significant | Comparative |
| | | | | cracks | |

From the results shown in Table 4, it can be seen that the substrates for image display devices of the present invention are unlikely to suffer from change by heat and have superior durability.

Moreover, the results shown in Tables 3 and 4 also indicate the followings.

The plastic substrates obtained from the organic-inorganic composite compositions of the present invention have superior optical characteristics and a small thermal expansion coefficient. Moreover, reduction of mechanical strength after formation of organic-inorganic composite is smaller and thus more favorable compared with conventional resins. Furthermore, the substrates for image display devices obtained from the plastic substrates of the present invention are unlikely to suffer from thermal deformation and have durability that cannot be attained with organic-inorganic composite compositions obtained from conventional resins.

### 3. Production of Image Display Devices

### <Preparation of Circularly Polarizing Films>

The λ/4 plate described in Japanese Patent Laid-open Publication Nos. 2000-826705 and 2002-131549 was laminated on each of the substrates for image display devices of the present invention F-101, F-103, F-105, F-107, comparative substrates F-111, F-112 and F-113 on the side opposite to the transparent conductive layer side, and the polarizing plate described in Japanese Patent Laid-open Publication No. 2002-865554 was further laminated thereon to prepare a circularly polarizing plate. The λ/4 plate and the polarizing plate were disposed so that the transmission axis of the polarizing film and the lagging axis of the λ/4 plate should make an angle of 45°.

### <Preparation of TN Type Liquid Crystal Display Devices>

An oriented polyimide film (SE-7992 produced by Nissan Chemical Industries, Ltd.) was provided on the transparent conductive layer (ITO) side of each of the substrates for image display devices of the present invention F-101, F-103, F-105, F-107, comparative substrates F-111, F-112 and F-113 as well as an electrode side of a glass substrate provided with an aluminum reflective electrode having fine unevenness on the surface. The substrates were subjected to a heat treatment at 200° C. for 30 minutes. As a result, no increase in resistance and no increase in gas permeability were observed at all for the substrates according to the present invention. On the other hand, they increased more than 2 times in all of the comparative substrates.

After they were subjected to a rubbing treatment, two substrates (glass substrate and plastic substrate) were laminated via a spacer having a thickness of 1.7 μm so that the oriented films should face each other. The directions of the substrates were adjusted so that the rubbing directions of two of the oriented films should cross at an angle of 1100. Liquid crystal (MLC-6252, Merck Ltd.) was injected into the gap between the substrates to prepare a liquid crystal layer. As described above, TN type liquid crystal cells having a twisting angle of 70° and Δnd of 269 nm were prepared.

Further, the aforementioned γ/4 plate and polarizing plate were laminated on each substrate for image display devices on the side opposite to the ITO side to prepare reflective type liquid crystal display devices. Good images were obtained with those utilizing the substrates for image display devices of the present invention. On the other hand, those utilizing the comparative substrates generated black spot defects (image portions became fine black spots, and thus images were not displayed) due to reduction of gas barrier property and color drift due to cracks in the conductive layer.

### <Production of STN Type Liquid Crystal Display Devices>

An oriented polyimide film (SE-7992 produced by Nissan Chemical Industries, Ltd.) was provided on each of the substrates for image display devices of the present invention F-101, F-103, F-105, F-107, comparative substrates F-111, F-112, F-113 and a glass substrate laminated with an ITO layer on the transparent electrode (ITO) layer side. The substrates were subjected to a heat treatment at 200° C. for 30 minutes. As a result, no increase in resistance and no increase in gas permeability were observed at all for those utilizing the substrates of the present invention. On the other hand, they increased more than 2 times in all of those utilizing the comparative substrates. Two of substrates (glass substrate and plastic substrate) were laminated via a spacer having a thickness of 6.0 μm so that the oriented films should face each other. The directions of the substrates were adjusted so that the rubbing directions of two of the oriented films should cross at an angle of 60°. Liquid crystal (ZLI-2977, Merck Ltd.) was injected into the gap between the substrates to prepare a liquid crystal layer. As described above, STN type liquid crystal cells having a twisting angle of 240° and Δnd of 791 nm were prepared.

Further, the aforementioned γ/4 plate and polarizing plate were laminated on each liquid crystal cell on the glass substrate side or plastic substrate side, and a light guide panel and a light source were disposed under the liquid crystal cell to obtain transmission type liquid crystal display devices. Good images were obtained with those utilizing the plastic substrates of the present invention. On the other hand, those utilizing the comparative substrates generated black spot defects (image portions became fine black spots, and thus images were not displayed) due to reduction of gas barrier property and color drift due to cracks in the conductive layer. The occurring rate of these defects are represented by a ratio of area where these defects occurred confirmed by visual inspection on a liquid crystal display substrate assembled by using each liquid crystal cell and displaying white color for the total display area with respect to the total display area.

### <Preparation of Organic EL Devices>

By using the plastic substrates of the present invention F-101, F-103, F-105 and F-107, organic EL devices having a structure comprising a protective layer (outermost surface had a antireflection function), the aforementioned circularly polarizing plate (the ITO layer of the plastic substrate of the present invention was disposed on the organic EL device side), organic EL device and reflective electrode from the observer side were prepared according to Japanese Patent Laid-open Publication No. 2000-267097. Those according to the present invention showed good performance.

### <Preparation of TFT Arrays>

TFT arrays were prepared by using the plastic film substrates of the present invention F-101, F-103, F-105 and F-107 according to the method described in International Patent Publication in Japanese (Kohyo) No. 10-512104. Even when the substrates were exposed to dimethyl sulfoxide as a solvent for removing resist or developer for photolithography during the preparation process, they do not show changes such as getting cloudy.

The film of the present invention has superior durability, heat resistance and gas barrier performance and can maintain superior gas barrier performance even when it is bent, and therefore it can be suitably used for various image display devices, in particular, organic EL devices.

The present disclosure relates to the subject matter contained in Japanese Patent Application No. 043970/2004 filed on Feb. 20, 2004 and Japanese Patent Application No. 271938/2004 filed on Sep. 17, 2004, which are expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An organic-inorganic composite composition comprising an inorganic compound and a resin having a glass transition temperature of 250° C. or higher, wherein the resin is a polymer having a spiro structure represented by the following formula (I): 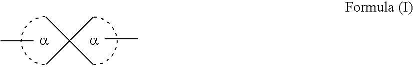
wherein the rings α represent a monocyclic or polycyclic ring, and two of the rings are bound via a spiro bond.

2. The organic-inorganic composite composition according to claim 1, wherein the inorganic compound is a metal oxide obtained by hydrolysis and polycondensation reactions based on a sol-gel method.

3. The organic-inorganic composite composition according to claim 1, wherein the inorganic compound has a negative coefficient of linear expansion.

4. The organic-inorganic composite composition according to claim 1, wherein the metal atom constituting the metal oxide is a metal atom selected from the group consisting of silicon, zirconium, aluminum, titanium and germanium.

5. A plastic substrate comprising the organic-inorganic composite composition according to claim 1.

6. The plastic substrate according to claim 5, which has a content of the metal oxide of 5 to 70 weight % and a thickness of 40 to 200 μm.

7. The plastic substrate according to claim 5, wherein thermal deformation temperature of the substrate is increased by 2° C. or more by inclusion of the metal oxide.

8. The plastic substrate according to claim 5, wherein thermal expansion coefficient of the substrate is decreased by 20 ppm/° C. or more by inclusion of the metal oxide.

9. A plastic substrate having a transparent conductive layer, which comprises the plastic substrate according to claim 5 and a transparent conductive layer formed on the plastic substrate.

10. A gas barrier laminate film comprising a base material film containing an inorganic compound and at least one set of inorganic layer and organic layer formed on the base material film, wherein the base material film is a film comprising a resin having a glass transition temperature of 250° C. or higher, and having a spiro structure represented by the following formula (I) 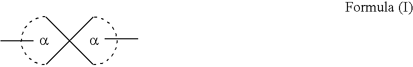
wherein the rings α represent a monocyclic or polycyclic ring, and two of the rings are bound via a spiro bond.

11. The gas barrier laminate film according to claim 10, wherein the inorganic compound is a metal oxide obtained by hydrolysis and polycondensation reactions based on a sol-gel method.

12. The gas barrier laminate film according to claim 10, wherein the inorganic compound has a negative coefficient of linear expansion.

13. The gas barrier laminate film according to claim 10, wherein the base material films is a plastic substrate containing an organic-inorganic composite composition comprising an inorganic compound and a resin having a glass transition temperature of 250° C. or higher.

14. An image display device utilizing a plastic substrate containing an organic-inorganic composite composition comprising an inorganic compound and a resin having a glass transition temperature of 250° C. or higher or the gas barrier laminate film according to claim 10 as a substrate.
